(19) United States
(12) Patent Application Publication
(10) Pub. No.: US 2022/0068563 A1
(43) Pub. Date: Mar. 3, 2022

(54) PROCESS FOR PRODUCING A POLY(VINYLIDEN FLUORIDE) DIELECTRIC MATERIAL FOR CAPACITOR WITH RICH BETA CRISTALLINE PHASE

(71) Applicant: Queen Mary University of London, London (GB)

(72) Inventors: Emiliano Bilotti, London (GB); Michael J. Reece, London (GB)

(21) Appl. No.: 17/421,048

(22) PCT Filed: Jan. 7, 2020
(86) PCT No.: PCT/GB2020/050034

§ 371 Date: Jul. 7, 2021

(30) Foreign Application Priority Data
Jan. 7, 2019 (GB) 1900189.0

(51) Int. Cl. H01G 4/18; C08L 27/16; B29C 48/00

(52) U.S. Cl. CPC H01G 4/186; B29K 2027/16; B29C 48/0019; C08L 27/16

(57) ABSTRACT

The present invention is concerned with a dielectric material comprising a fluoropolymer, wherein at least part of the crystalline region of the fluoropolymer is in the β-phase. The dielectric material of the present invention may show relaxor-like ferroelectricity. The present invention also relates to a novel method of producing such a material, and the use of such a material in a high energy density capacitor. The method comprises layering sheets of PVDF on one another and applying pressure to the multilayer under a temperature which is preferably within 40° C. of the temperature of fusion. Further, the film is preferably quenched.

### FIELD OF THE INVENTION

The present invention is concerned with a dielectric material comprising a fluoropolymer, wherein at least part of the crystalline region of the fluoropolymer is in the β-phase. The dielectric material of the present invention may show relaxor-like ferroelectricity. The present invention also relates to a novel method of producing such a material, and the use of such a material as a high energy density capacitor.

### BACKGROUND TO THE INVENTION

Polymer based dielectrics arc the principal candidate materials for high power density electric energy storage applications because they exhibit superior processability, high dielectric breakdown strength and exceptional self-healing properties. The most promising polymeric materials for this application belong to the family of poly(vinylidene fluoride) (PVDF) due to its ferroelectric nature. However, the ability to produce a polar phase with relaxor-like behaviour and high energy storage density in PVDF is a major challenge, thus limiting its practical applications. To date, this has been achieved using complex and expensive synthesis of copolymers and terpolymers or via irradiation with high-energy electron-beam or γ-ray radiations.

The demands of reducing both CO₂ emissions and the consumption of fossil fuels require an enhancement of energy efficiency and the long-term pursuit of renewable and sustainable energy sources (such as solar, wind, wave, etc.). These energy sources are intermittent, and it is therefore of paramount importance to develop efficient, low-cost and environmentally friendly electric energy storage systems. Currently there are three main options: batteries, electrochemical capacitors and dielectric capacitors [1].

Batteries with high energy density (lead-acid battery: 200-400 J/cm³ and lithium ion: 900-2500 J/cm³) and low power density (<500 W/kg) are usually used for long-term applications (>100 s), while capacitors with high power density (electrochemical capacitors: 10¹-10⁶ W/kg and dielectric capacitors: ˜10⁸ W/kg) are for short-term applications (<0.01 s) [2].

Electrochemical capacitors have at least an order of magnitude higher energy density compared to dielectric capacitors but suffer from lower power density. Only dielectric capacitors can meet the requirement of ultrahigh power density (up to ˜10⁸ W/kg), which makes them important for high power applications such as satellite communication, aerospace launchers, etc. However, the application of dielectric capacitors is currently limited by their low energy density. For example, the best performing commercial dielectric capacitor, biaxially-orientated polypropylene (BOPP), only has an energy density of ˜1-2 J/cm³, being an order of magnitude lower compared to commercial electrochemical capacitors (20-29 J/cm³)[3]. Therefore, achieving high energy density in dielectric capacitors is a major challenge to extend the use of dielectric energy storage. The mechanism of energy storage for dielectric capacitors is generally described by the following equation:

$${U}_{r e c} = \int E d D$$

where E and D are electric field and displacement, respectively. Specifically, for linear dielectrics,

$${U}_{r e c} = \int EdD = \frac{1}{2} D E = \frac{1}{2} {ɛ}_{0} {ɛ}_{r} {E}_{b}^{2}$$

where ε₀ and εᵣ are the vacuum and relative dielectric constant, respectively, and E_{b} is the breakdown field. U_{rec} has a quadratic-dependence on E_{b}. While polymers possess much lower dielectric constants compared to inorganic materials, they have at least an order of magnitude higher energy storage capacity as a result of their much higher breakdown fields (several hundred kV/mm). Apart from their high E_{b}, polymers have additional advantages, like low density, high processability, mechanical flexibility and high toughness.

The relatively low εᵣ of polymers is the limiting factor for their energy storage capacity. The above mentioned BOPP has a εᵣ of ˜2, resulting in its low U_{rec} (˜1-2 J/cm³). Polar polymers, with dipole moments in their polymer chains, can exhibit much higher εᵣ. Poly(vinylidene fluoride) (PVDF), a semi-crystalline polymer, is a typical example with a εᵣ of ˜10 [4]. PVDF has at least four well-defined phases, α-, β-, γ- and δ-phase. The α-phase is non-polar, while the other three are polar phases, of which the β-phase shows the highest polarization and is the most ferroelectric favourable phase [5]. However, cooling it from the melt leads to the predominant crystallization of the a-phase, with fairly low content of β-phase, <8%, [6] which can be increased by solid-state drawing and/or high electric field poling (up to ˜50-85%) [7]. Thus, PVDF exhibits broad ferroelectric hysteresis loops and is not suitable for energy storage [8]. Relaxor (RFE) and anti-ferroelectric (AFE) behaviours are favourable for energy storage [8], which have only been reported in the case of electron- or γ-irradiated poly(vinylidenefluoride-trifluoroethylene) (PVDF-TrFE) [9], ternary polymers poly (vinylidenefluoride-trifluoroethylene-chlorofluoroethylene) (PVDF-TrFE-CFE) [10] and poly(vinylidenefluoride-trifluoroethylene-chlorotrifluoroethylene (PVDF-TrFE-CTFE) [11] and PVDF-based graft polymers such as (PVDF-CTFE)-graft-polystyrene [12]. However, the complexity and cost of the above polymers constitutes a barrier to their use in practical applications.

In summary, there is a need for a polymer dielectric material with a high energy density. Further, there is a need for an easy way to form PVDF which is predominantly in a polar phase, preferably with relaxor-like ferroelectric behaviour, in order to allow it to be used commercially.

### SUMMARY OF THE INVENTION

The present invention is based on the unexpected discovery that ferroelectric β-PVDF with relaxor-like behaviour can be produced using the facile process of press-and-folding (P&F), without the need of any hazardous gases, solvents, electrical or chemical treatments. The simple and scalable processing route described herein generates unprecedentedly high β-phase content (˜95% of crystalline phases) and is generally applicable to PVDF with different molecular weights (M_{W}). Further, it was unexpectedly discovered that β-PVDF produced according to this method exhibits relaxor-like ferroelectricity and ultra-high energy density.

Hence the present invention provides a novel material which has applications in the field of capacitors, as well as a simple scalable method of producing said material.

In one aspect the present invention provides a dielectric material comprising a fluoropolymer, wherein the fluoropolymer comprises poly(vinylidene fluoride) (PVDF), wherein greater than 85% of the crystalline region of the PVDF is β-phase.

In an embodiment the fluoropolymer is poly(vinylidene fluoride) homopolymer.

In a further embodiment greater than 90% of the crystalline region of the fluoropolymer is β-phase, preferably greater than 95% of the crystalline region of the fluoropolymer is β-phase.

In a further embodiment the % crystallinity of the fluoropolymer is greater than 30%, when measured using differential scanning calorimetry (DSC).

In a further embodiment the % crystallinity of the fluoropolymer is greater than 35%, preferably greater than 40%, when measured using differential scanning calorimetry (DSC).

In a further embodiment the recoverable energy density of the material, U_{rec} is 15 J/cm³ or greater when measured using an electric field of 800 kV/mm.

In a further embodiment the recoverable energy density of the material, U_{rec} is 20 J/cm³ or greater, preferably 25 J/cm³ or greater, when measured using an electric field of 800 kV/mm.

In a further embodiment the recoverable energy density, U_{rec}, is 50 J/cm³ or greater, when measured using an electric field of 1000 kV/mm.

In a further embodiment the M_{W} of the fluoropolymer is greater than 200 kg/mol.

In a further embodiment the M_{W} of the fluoropolymer is greater than 500 kg/mol, preferably greater than 600 kg/mol.

In a further embodiment the fluoropolymer comprises small crystallites, wherein the mean size of crystallites is less than 20 nm, preferably less than 10 nm, more preferably less than 5 nm.

In a further embodiment the energy efficiency (η) of the dielectric material is greater than 25%, preferably greater than 35%, more preferably greater than 50% when measured using an electric field of 300 kV/mm.

In a further embodiment the material has relaxor-like ferroelectric properties.

In an embodiment the present invention provides a process for producing a fluoropolymer based dielectric material, such as a film, comprising the steps of (a) providing a layered fluoropolymer sample and (b) pressing the layers of the layered fluoropolymer sample together via the application of pressure.

In a further embodiment the cycle of steps (a) and (b) is repeated a total of n times, wherein n is greater than 1, preferably greater than 3, more preferably greater than 5.

In a further embodiment, in at least one step (a) the layered fluoropolymer is obtained by stacking multiple fluoropolymer samples.

In a further embodiment in at least one step (a) the layered fluoropolymer is obtained by folding a fluoropolymer sample upon itself a number of times.

In a further embodiment in at least one step (a) the layered sample is provided by rolling a fluoropolymer sample up to form a multi-layered tube.

In a further embodiment the cycle of steps (a) and (b) is repeated a total of n times by further folding the fluoropolymer sample obtained in step (b) upon itself, to provide a further layered fluoropolymer sample, wherein n is greater than 1, preferably greater than 3, more preferably greater than 5.

In a further embodiment, when the fluoropolymer is folded back upon itself in step (a), it is folded 1 to 5 times, preferably 1 to 3 times.

In a further embodiment, the number of layers in step (a) is greater than or equal to 2, preferably greater than or equal to 4, more preferably greater than or equal to 6.

In a further embodiment the material is quenched after at least one step (b).

In a further embodiment at least one of the processing cycles, step (a) and/or step (h) is carried out at a temperature greater than or equal to 25° C. and less than or equal to 210° C., preferably greater than or equal to 70° C. and less than or equal to 185° C.

In a further embodiment all of the pressing steps (b) are carried out at a temperature greater than or equal to 25° C. and less than or equal to 210° C., preferably greater than or equal to 70° C. and less than or equal to 185° C.

In a further embodiment, in at least one, preferably all, of the processing cycles the polymer is heated to within 40° C. of the melting temperature of the polymer during step (a) and/or step (b).

In a further embodiment, in at least one, preferably all, of the processing cycles the pressing step (b) is performed at a pressure of greater than or equal to 10 MPa.

In a further embodiment, in at least one, preferably all, of the processing cycles, the pressing step (b) of the process is preferably performed at a pressure of greater than or equal to 20 MPa, and less than or equal to 200 MPa, more preferably greater than or equal to 50 MPa and less than or equal to 180 MPa.

In a further embodiment of the process of the present invention, the fluoropolymer is PVDF, preferably PVDF homopolymer.

In a further embodiment of the process of the present invention, the process is performed in a continuous manner. In one embodiment, such a process comprises an extrusion step to form a sheet; a folding step and a rolling step, wherein the material is compressed between a roller and a surface and/or a further roller.

The present invention also provides a dielectric material obtainable by any of the processes described above.

The present invention also provides a capacitor comprising any of the above described dielectric materials.

### BRIEF DESCRIPTION OF THE FIGURE

FIG. 1(a) shows a schematic demonstration of P&F technique.

FIG. 1(b) shows cross-sectional SEM images of P&F samples folded at 165° C. after different numbers of folding cycles. A fine and discrete layered structure is generated during P&F.

FIG. 1(c) shows the evolution of crystalline phase revealed by the FTIR absorbance spectrum. The initial hot pressed (HP) films mainly crystallized into α-phase, with characteristic peaks at 764 cm⁻¹, 975 cm⁻¹ and 1212 cm⁻¹ highlighted by asterisks, and transformed to about 95% β-phase after seven folding cycles. The horizontal shaded area indicates the reported values of fraction of β-phase in commonly stretched PVDF films, and the dashed line represents the fraction of β-phase for the stretched film used in Example 1.

FIG. 1(d) shows a comparison of electric energy storage properties of P&F and stretched films, which includes ferroelectric hysteresis loops, schematic calculations of stored energy of ferroelectric materials and the recoverable energy density U_{rec} and energy efficiency η of P&F and stretched films. The above used PVDF has M_{W} of 670-700 kg/mol,

FIG. 2(a) shows an FTIR of P&F, samples with different M_{W}, which indicates the formation of γ-phase in PVDF with low M_{W} at higher T_{fold} (denoted by the γ-characteristic band at 1234 cm⁻¹) and the preference of high M_{W} for the transition to β-phase (inset).

FIG. 2(b) shows the demonstration of phase evolution with T_{fold} and M_{W} during P&F, This figure also shows a schematic diagram of chain conformation, crystal structure and polarization of PVDF. The initial HP (no folding) films are mainly α-phase, with two trans-gauche-trans-gauche′ (TGTG′) chains anti-parallel packed in a pseudo-orthorhombic unit cell. The symbols and arrows represent the in-plane and out-of-plane contributions to the dipole moments. After P&F at different temperatures (room temperature-Tₘ), films formed into β-phase with all-trans (TTT) chain conformation and with a content of above 90%. The formation of β-phase favours low T_{fold} and high M_{W}.

FIG. 2(c) shows the evolution of the dimension of sample and the corresponding applied pressure during P&F, which suggests the increase of overall thickness and the decrease of surface area (as a result of the increase of pressure) along with folding cycles. The inset AFM topography images of initial HP (left) and P&F (right) after seven cycles (M_{W}: 670-700 kg/mol) show the evolution of morphology, from large grains in HP films to small granules after P&F.

FIG. 2(d) shows the comparison of the phase transition in the films with a single layer and six multi-stacked layers at three different pressures, 120, 667 and 3000 MPa, which indicates that the high pressure and layered structure favours the formation of β-phase.

FIG. 3 shows the ferroelectric measurement of Current-Electric field (IE) and Displacement-Electric field (PE) of P&F after seven cycles for PVDF, M_{W}: 180 kg/mol P&F films (FIG. 3(a)), and PVDF, M_{W}: 534 kg/mol P&F films (FIG. 3(b)).

FIG. 3(c) shows a comparison of remnant polarization Pᵣ and maximum polarization Pₘₐₓ of P&F films with different M_{W}. This figure also shows a schematic diagrams of polar structure change during charging and discharging processes, where the blocks at the top of the figure represent the crystallites, and the lines overlaying these blocks represent the polymer chains with arrows denoting the dipole moment, and the dashed lines highlight the polar structure, which was enhanced and grew larger under electric field.

FIG. 4 shows DSC curves recorded during the first heating run, demonstrating the thermal properties of P&F samples for PVDF with M_{W} of 180 kg/mol (FIG. 4(a)); PVDF with M_{W} of 534 kg/mol (FIG. 4(b)); and PVDF with M_{W} of 670-700 kg/mol (FIG. 4(c)). All P&F films were produced at 165° C. and 240 bar for 5 minutes.

FIG. 5 shows an FTIR of P&F samples after seven cycles but at different folding temperatures (T_{fold}) and 240 bar for 5 minutes for PVDF with M_{W} of 180 kg/mol (FIG. 5(a)); PVDF with M_{W} of 534 kg/mol (FIG. 5(b)); and PVDF with M_{W} of 670-700 kg/mol (FIG. 5(c)). The transformation of β-phase show dependence of T_{fold}, low T_{fold} favours the transition to β-phase (indicated by the increase of peak intensity at 840 cm⁻¹ and decrease of peak intensity at 764 cm⁻¹), moderately high T_{fold} leads to the formation of γ-phase in PVDF with relatively lower M_{W} (180 and 534 kg/mol) and incomplete transition in high M_{W} (670-700 kg/mol) and even higher T_{fold} cannot trigger the phase transition.

FIG. 6 shows the fraction of β-phase for samples pressed once at 165° C. and 240 bar for 5 minutes, followed by cold water quenching in the presence of pressure. All of the samples were of the same dimension (3 cm×1.5 cm×(0.2-0.25) cm) but composed of different layers.

FIG. 7 shows re-measured ferroelectric Current-Electric field (IE) and Displacement-Electric field (PE) of 180 kg/mol P&F (FIG. 7(a)), and 534 kg/mol P&F (FIG. 7(b)) after the first testing. The different IE curve at 200 kV/mm in P&F samples with M_{W} of 180 kg/mol, demonstrates field-induced polar structural changes during electric measurement, while no obvious change between the first and second measured I-P-E in P&F with M_{W} of 534 kg/mol.

FIG. 8 shows XRD data of initial HP films, P&F films after 7 cycles at 165° C. and 240 bar for 5 minutes and films solid-state drawn to failure at 100° C. and 10 mm/min. Combined with FTIR data (FIG. 1(c)), the initial HP films are mainly a-phase, of which the characteristic peaks are at 2θ about 17.8° (100)_{α}, 18.7° (020)_{α}, 20.2° (110)_{α}, 26,7° (021)_{α} and 38.9° (210)_{α} (indexed in figure). P&F samples with low M_{W} (180 kg/mol) show a shoulder peak at 2θ=18.0° due to the reflection of (110)_{α} and (020)_{α} (highlighted in an ellipse region) coming from the residual non-polar α-phase (˜10%). Conversely, the folded samples with high M_{W} (670 and 534 kg/mol) only display reflection from β-phase, (110)/(200)_{β} and (020)/(101)_{β}, at 2θ about 20.7° and 36.5°, respectively. The stretched film, of which the FTIR and ferroelectric I-P-E are presented in FIG. 1(d), contains a mixture of α- and β-phases and displays mixed reflections from α- and β-crystals.

FIG. 9 shows the frequency dependence of dielectric spectra before and after ferroelectric testing for P&F samples prepared at 165° C. and 240 bar for 5 minutes with M_{W} of 180 kg/mol (FIG. 9(a)) and 670-700 g/mol (FIG. 9(b)). The decrease of dielectric constant of P&F films with M_{W} of 180 kg/mol after poling suggests the growth of polar structures. A small but clear piezoelectric resonance peak can be seen in P&F films with M_{W} of 180 kg/mol (highlighted in ellipse). However, P&F films with M_{W} of 670-700 kg/mol do not show a piezoelectric resonance peak, which demonstrates the reversibility of dipoles.

FIG. 10 shows the temperature dependence of dielectric spectra of initial HP and P&F PVDF films prepared at 165° C. and 240 bar for 5 minutes with different molecular weights: (a) 180; (b) 534 and (c) 670-700 kg/mol. The HP films show two main relaxation behaviours, the low temperature glass transition (˜−8° C. at 100 kHz) and high temperature α_{c} relaxation (˜50-150° C.) originating from the motions of polymer chains in the crystalline regions. The glass transition temperature (T_{g}) hardly varied (˜−8° C. at 100 kHz) among films with different M_{W}. However, the α_{c} relaxation in PVDF with M_{W} of 180 kg/mol is not evident and the loss tangent increased abruptly at temperatures higher than 50° C., demonstrating the high mobility of polymer chains in PVDF with low M_{W}. Apart from T_{g}, the P&F films show broad peaks ranging from 50-150° C., which suggests that the small-sized polar structures are not stable at high temperatures due to the low thermal stability and severe thermal fluctuation.

FIG. 11(a) shows a schematic diagram of the roll and press method compared with pressing and folding with a zigzag pattern and stacking polymeric samples via cutting and pressing. FIG. 11(b) shows a schematic of more loosely rolled films prior to pressing with d_{gap} of 0, 3 and 5 mm. FIG. 11(c) shows a FTIR spectrum of films prepared in each of the three methods (roll and press (top), zigzag and press (middle) and cut and press (bottom)). FIG. 11(d) shows XRD spectra, acquired using Cu/Kα radiation, of films roll-pressed, zigzag-pressed and cut-pressed at 165° C., FIG. 11(e) shows FTIR spectra of films prepared via roll and press method with d_{gap} of 0, 3 and 5 mm, respectively. FIG. 11(f) shows XRD spectra, acquired using Cu/Kα radiation, of the same roll and press films of FIG. 11(e).

FIG. 12(a) shows XRD spectra, acquired using Cu/Kα radiation, of roll and pressed films with d_{gap} of 3 mm produced in Example 4, which have been annealed at 165° C., 140° C., 80° C. and 60° C. FIG. 12(b) shows the peak shift of 20.8° (squares) and induced internal strain (stars) of the above annealed roll and pressed films. FIG. 12(c) shows unipolar Displacement-Electric field (PE) of the sample annealed at 60° C. mentioned above. FIG. 12(d) shows the recoverable energy density U_{rec} (circles) and energy efficiency η (stars) at dielectric breakdown strength of the sample annealed at 60° C. mentioned above.

FIG. 13(a) shows a schematic demonstration of PVDF structure change with P&F cycle increasing, including α to β phase transformation, reduced crystallite size, induced preferred orientation and broadened interchain distance resulting from the accumulated in-plane tensile internal stress. FIG. 13(b) shows an SEM image of the cross-section of the 6-fold PVDF film produced in Example 5. FIG. 13(c) shows the Current-Electric field (IE) and

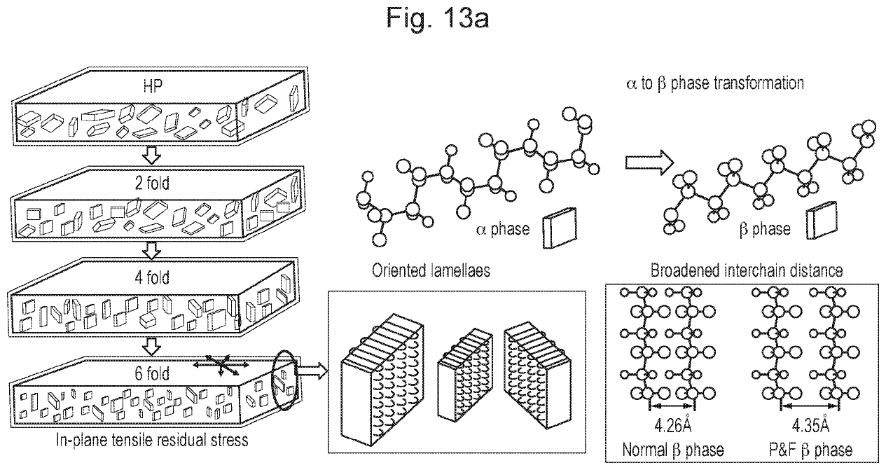

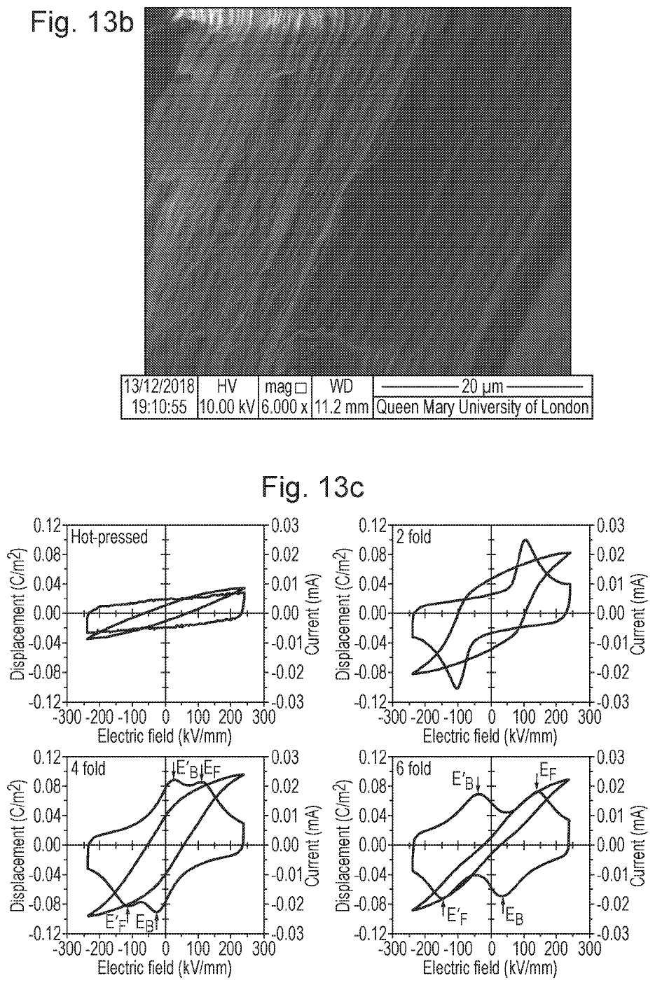

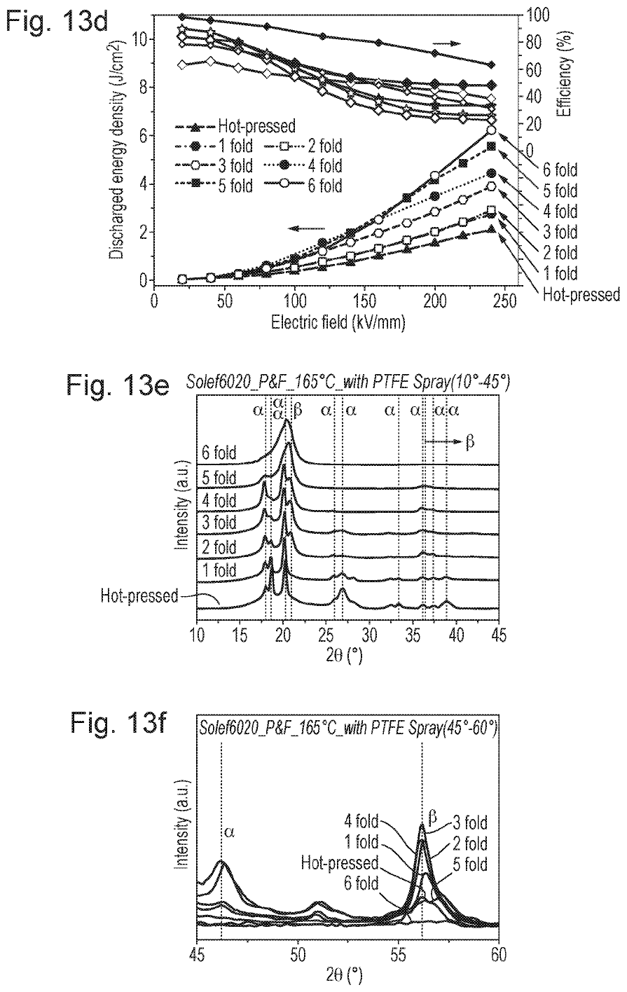

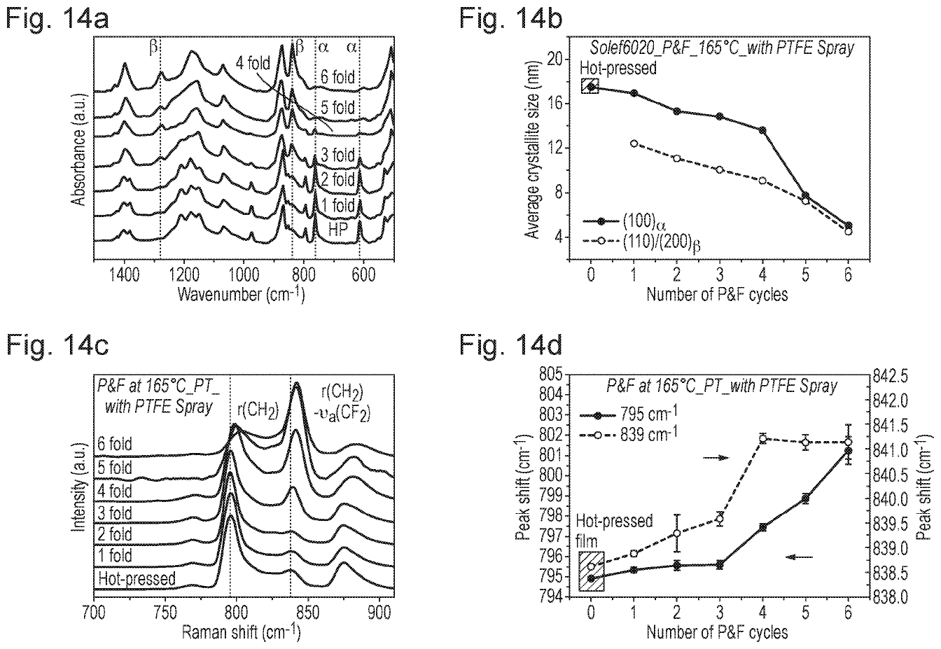

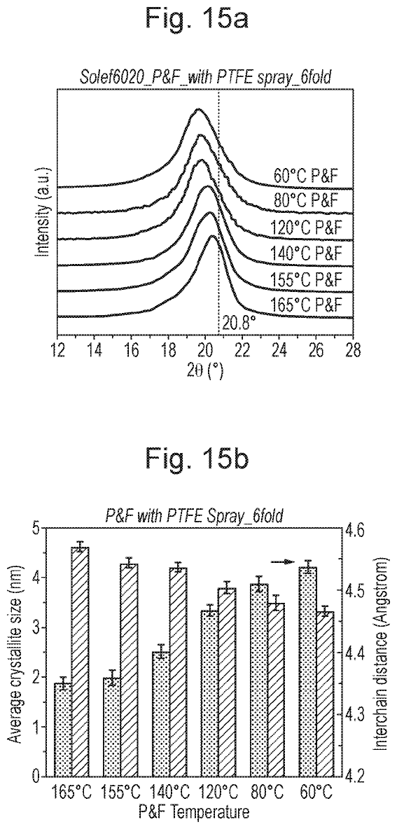

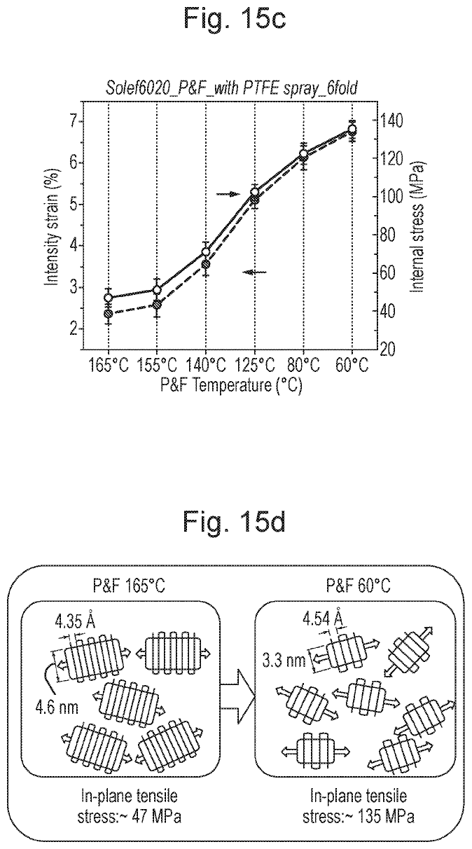

Displacement-Electric field (PE) loops at 240 kV/mm of hot-pressed PVDF film and press-folded PVDF film at 165° C. with 2, 4 and 6 P&F cycles, as described in Example 5. FIG. 13(d) shows discharged energy density (recoverable energy density) (circles) and charge-discharged efficiency (diamonds) at different electric field strengths for the PVDF samples produced in Example 5. The lines representing efficiency correspond to 6 press, 5 press, hot-pressed, 4 press, 1 press, 2 press and 3 press films, respectively, from top to bottom at the right hand edge. FIG. 13(e) also shows XRD spectra from 10° to 45°, acquired using Cu/Kα radiation, and (f) from 45° to 60° (enlarged). FIG. 13(f) shows the XRD diffraction α and β peak position shift of hot-pressed PVDF film and press-folded PVDF film at 165° C. from 1 to 6 P&F cycles as described in Example 5.

FIG. 14 shows structure evolution of hot-pressed PVDF films after 1 to 6 P&F cycles at 165° C., as discussed in Example 5 . FIG. 14(a) shows FTIR spectra of the above samples. The film was shown to experience α to β phase transformation after 6 cycles of pressing and folding. FIG. 14(b) shows the average crystallite sizes of α and β phases, D_{(100)α} (upper line) and D_{(100)/(200)β} (lower line) which are calculated using the Scherrer equation, as discussed in Example 5. The average crystallite size keeps decreasing with increasing of P&F cycles and D_{(100)α} is higher than D_{(110)/(200)β} over the whole range. FIG. 14(c) shows a Raman spectra of the above samples. FIG. 14(d) shows Raman peak position shift of 795 cm⁻¹ (lower line) and 839 cm⁻¹ (upper line). The characteristic peak of a phase at 795 cm⁻¹, is ascribed to the rocking of CH₂ bonds and characteristic peak of β phase 839 cm⁻¹, originating from the rocking of CH₂ bonds and asymmetric stretching of CF₂ bonds, are both electric vectors perpendicular to the polymer chain orientation direction. Similar to the XRD peak shift, the Raman peak of both α and β phase experienced an obvious shift to higher Raman shift as the internal strain shortened the bond length and more energy were needed to activate these molecular vibrations.

FIG. 15 shows a comparison of PVDF films pressed and folded at temperatures from 60 to 165° C., as described in Example 6. FIG. 15(a) shows XRD spectra, acquired using Cu/Kα radiation, of the above described films. FIG. 15(b) shows the average crystallite size (right hand light grey bars) and interchain distance (left hand dark grey bars). FIG. 15(c) shows strain (right hand line) and internal stress (left hand line) for the above mentioned films. FIG. 15(f) shows a scheme of the structure evolution including in-plane tensile stress, crystallite size and interchain distance as the P&F temperature is lowered from 165° C. to 60° C.

### DETAILED DESCRIPTION OF THE INVENTION

The present invention is concerned with a dielectric material comprising a fluoropolymer, wherein at least part of the crystalline region of the fluoropolymer is in the β-phase. The fluoropolymer is preferably poly(vinylidene fluoride) (PVDF). More preferably the fluoropolymer is poly(vinylidene fluoride) homopolymer.

Preferably the crystalline region of the fluoropolymer contains greater than 80% β-phase, more preferably the fluoropolymer contains greater than 85% β-phase, even more preferably the fluoropolymer contains greater than 90% β-phase, yet more preferably the fluoropolymer contains greater than 93% β-phase, most preferably the fluoropolymer contains greater than 95% β-phase. In a most preferred embodiment the crystalline region of the fluoropolymer contains greater than or equal to 98% β-phase. The overall crystallinity of the sample may he determined via a suitable method, such as differential scanning calorimetry (DSC), for instance as shown in the Examples described herein. The % β-phase of the crystalline regions may be determined by Fourier-transform infrared spectroscopy (FTIR), or X-ray diffraction (XRD), or a combination thereof, for instance as shown in the Examples described herein.

Preferably the % crystallinity of the fluoropolymer is greater than 30%, when measured using differential scanning calorimetry (DSC). In a further embodiment, the % crystallinity of the fluoropolymer is greater than 35%, preferably greater than 40%, when measured using differential scanning calorimetry (DSC).

The material of the present invention preferably comprises more than 80 wt. %, more preferably more than 90 wt. %, even more preferably more than 95 wt. %, yet more preferably more than 98 wt. % of the fluoropolymer defined herein. In some embodiments the material of the invention consists of the fluoropolymer defined herein.

As used herein polymers may be straight chain, branched chain, comb, block, or any other structure. The polymers may be homogenous or heterogenous, and may have a gradient distribution of co-monomer units. Poly(vinylidene fluoride) (PVDF) of the present invention comprises at least 50 mole percent, preferably at least 65 mole percent, more preferably at least 80 mole percent, even more preferably at least 90 mole percent, even more preferably at least 95 mole percent, yet more preferably at least 98 mole percent of vinylidene fluoride monomer unit. Most preferably, the poly(vinylidene fluoride) of the present invention is poly(vinylidene fluoride) homopolymer.

Compositions according to the invention comprise a fluoropolymer comprising poly(vinylidene fluoride). The poly(vinylidene fluoride) is preferably poly(vinylidene fluoride) homopolymer, but may optionally comprise additional comonomer units. Suitable comonomer units include vinylidene fluoride (VDF), tetrafluoroethylene (TFE), trifluoroethylene (TrFE), chlorofluoroethylene (CFE), chloro-trifluoroethylene (CTFE), dichlorodifluoroethylene, chloro-difluoroethylene (CDFE), hexafluoropropene (HFP), vinyl fluoride (VF), hexafluoroisobutylene (IAMB), perfluorobutylethylene (PFBE), 1,2,3,3,3-pentafluoropropene, 3,3,3-trifluoro-1-propene, 2-trifluoromethyl-3,3,3-trifluoropropene, 2,3,3,3-tetrafluoropropene, 1-chloro-3,3,3-trifluoropropene, fluorinated vinyl ethers including perfluoromethyl ether (PMVE), perfluoroethylvinyl ether (PEVE), perfluoropropylvinyl ether (PPVE), perfluorobutylvinyl ether (PBVE), longer chain perfluorinated vinyl ethers, fluorinated dioxoles, partially- or per-fluorinated alpha olefins of C₄ and higher, partially- or per-fluorinated cyclic alkenes of C₃ and higher, and combinations thereof. Fluoropolymers useful in the present invention include the products of polymerization of the fluoromonomers listed above with vinylidene fluoride.

In an embodiment the fluoropolymer of the present invention is (PVDF-TrFE) in a molar ratio of about 50:50 mol. % or 65:35 mol. %. In another embodiment the fluoropolymer of the present invention is (PVDF-TFE) in a molar ratio of about 50:50 mol. % or 65:35 mol. %.

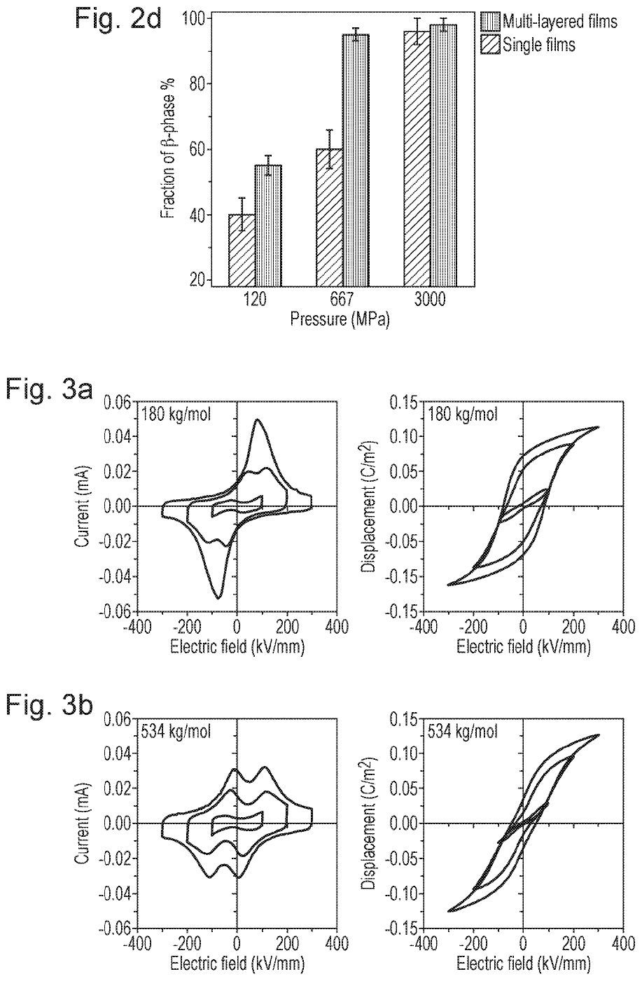

As used herein, the term β-phase refers to a crystalline phase of a fluoropolymer such as PVDF polymer, with all-trans chain configuration (TTT) (sec FIG. 2(b)).

As used herein, the term a-phase refers to a crystalline phase of a fluoropolymer such as PVDF, with two trans-gauche-trans-gauche′ (TGTG′) chains anti-parallel packed in a pseudo-orthorhombic unit cell (see FIG. 2(b)).

As used herein, the term γ-phase refers to a crystalline phase of a fluoropolymer such as PVDF, wherein the monomer units have chain conformation, trans-trans-trans-gauche-trans-trans-trans-gauche′ (TTTGTTTG′) (see FIG. 2(b)).

As used herein, the term relaxor-like behaviour refers to the property of having dipoles which are highly mobile and reversible, generating high saturated polarization and low remnant polarization and being suitable for energy storage.

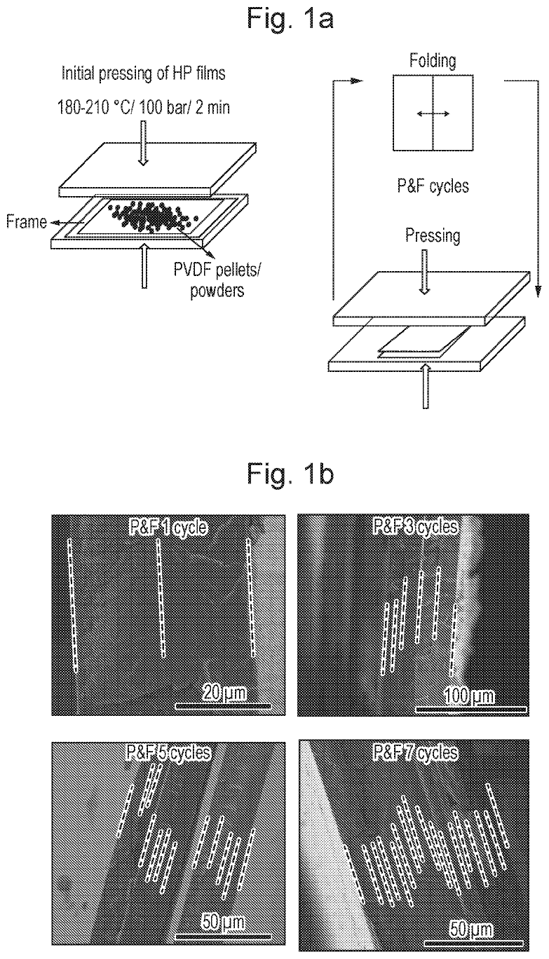

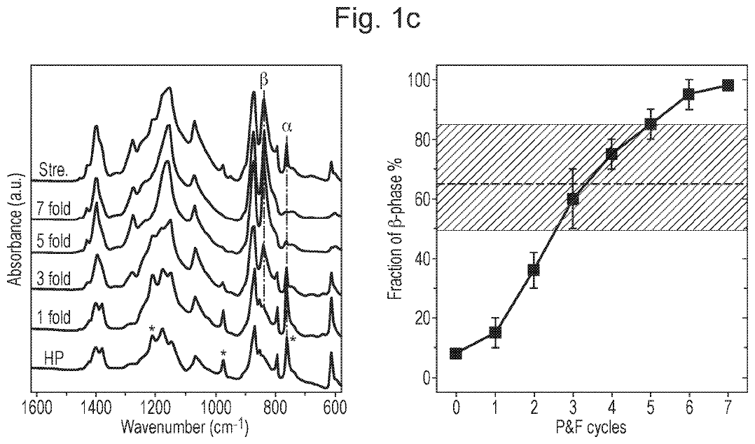

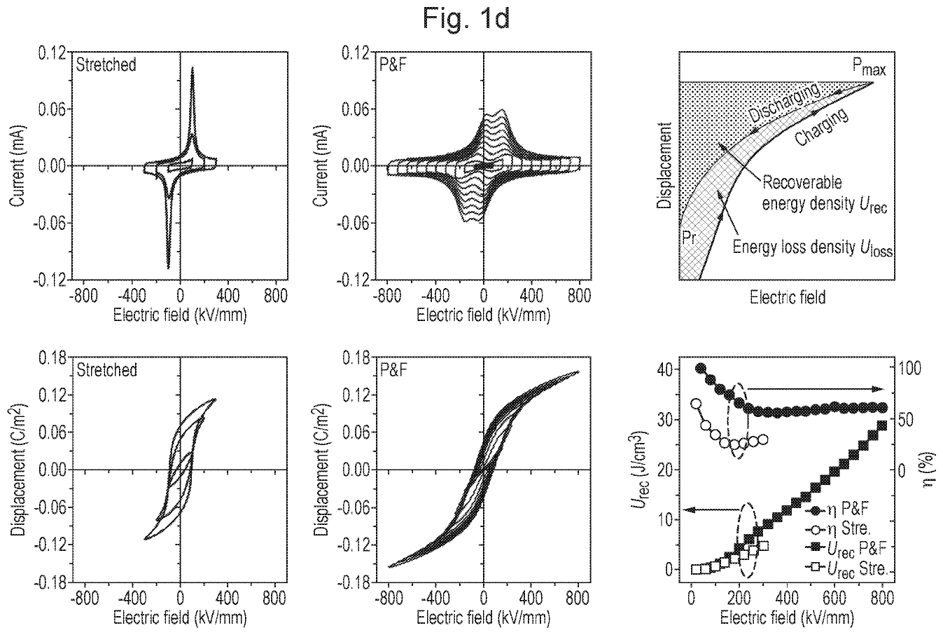

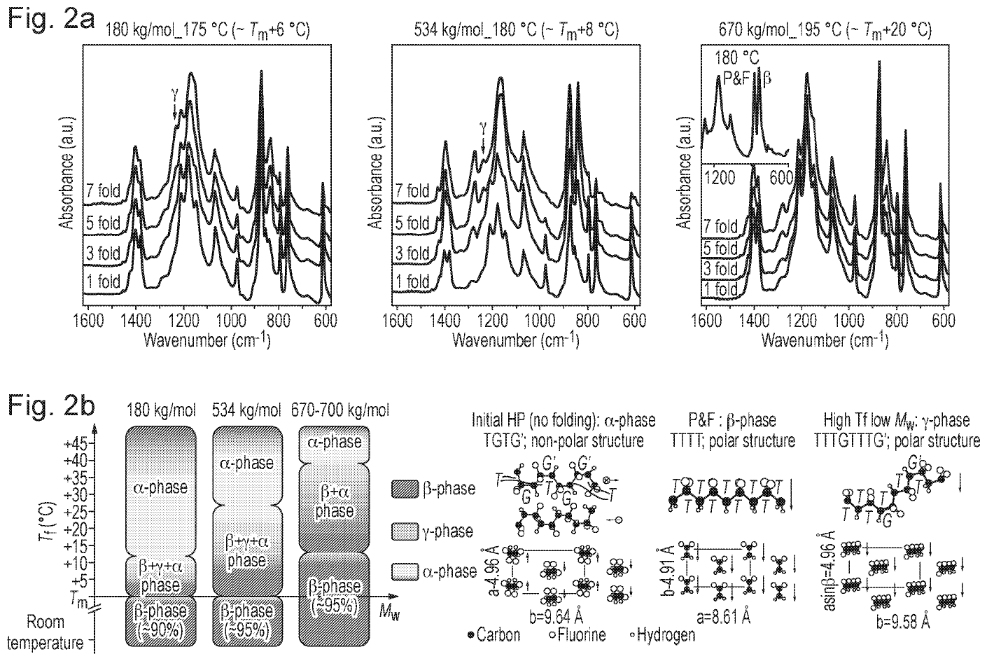

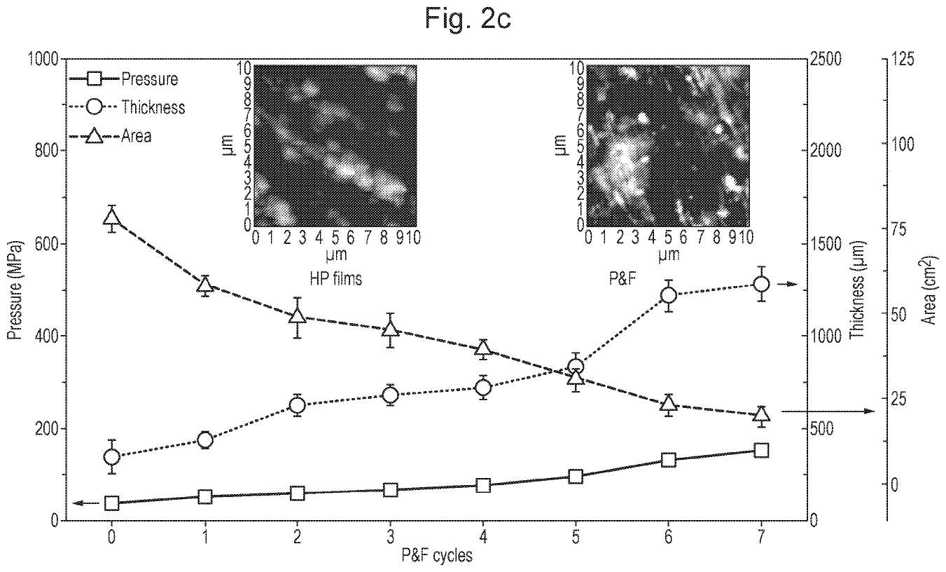

The materials of the present invention typically have high energy densities (U_{rec}). When measured using an electric field of 800 kV/mm, the dielectric materials of the present invention preferably have energy densities of 15 J/cm³ or greater, more preferably 20 J/cm³ or greater, even more preferably 25 J/cm³ or greater, most preferably 30 J/cm³ or greater. In some embodiments the dielectric materials of the present invention may have energy densities of 15 J/cm³ to 60 J/cm³, optionally, 15 J/cm³ to 50 J/cm³ when measured using an electric field of 800 kV/mm. When measured at an electric field of 300 kV/mm, the dielectric materials of the present invention preferably have energy densities of 5 J/cm³ or greater, more preferably 7 J/cm³ or greater. In some embodiments the dielectric materials of the present invention may have energy densities of 5 J/cm³ to 15 J/cm³, when measured using an electric field of 300 kV/mm. When measured using an electric field of 1000 kV/mm the dielectric materials of the present invention may preferably have energy densities of 40 J/cm³ or greater, more preferably 50 J/cm³ or greater. Optionally, the dielectric materials of the present invention may have energy densities of 40 J/cm³ to 60 J/cm³, when measured using an electric field of 1000 kV/mm, U_{rec} may suitably be calculated from a displacement/electric field plot, as shown in FIG. 1(d). The plot of displacement/electric field was measured using a triangle waveform at a frequency of 10 Hz and room temperature. The electrodes of the tested samples were prepared using gold-sputtering. The diameter and thickness of electrodes were 2 mm and 100-200 nm, respectively.

The materials of the present invention typically have high energy efficiencies (η). When measured using an electric field of 300 kV/mm, the dielectric materials of the present invention preferably have energy efficiencies of 30% or higher, more preferably 40% or higher, even more preferably 50% or higher. When measured using an electric field of 800 kV/mm, the dielectric materials of the present invention preferably have energy efficiencies of 50% or higher, more preferably 60% or higher, even more preferably 65% or higher. As used herein the term energy efficiency refers to the recoverable energy density (U_{rec}) divided by the energy loss density (Uₗₒₛₛ) plus the recoverable energy density, as shown in the equation below:

$$η = \frac{{U}_{r e c}}{{U}_{r e c} + {U}_{l o s s}} * 100 \%$$

The recoverable energy density and the energy loss density may suitably be obtained from a displacement/electric field plot, as shown in FIG. 1(d), and the energy efficiency η is therefore calculated using the above described equation.

The materials of the invention typically have high breakdown fields (E_{b}). The materials preferably have breakdown fields of 300 kV/mm or greater, more preferably 500 kV/mm or greater, even more preferably 700 kV/mm or greater, most preferably 750 kV/mm or greater. Breakdown field is herein defined as the field strength above which the material ceases to act as an insulator. The breakdown field was determined using the displacement/electric field plot which was measured using a triangle waveform at a frequency of 10 Hz and room temperature. The electrodes of the tested samples were prepared using gold-sputtering. The diameter and thickness of electrodes were 2 mm and 100-200 nm, respectively.

The materials of the invention typically have low remnant polarisations (Pᵣ) and high maximum polarisations (Pₘₐₓ). When measured using an electric field of 800 kV/mm, the dielectric materials of the present invention preferably have remnant polarisations of 0.06 C/m² or less, preferably 0.05 C/m² or less. When measured using an electric field of 800 kV/mm, the dielectric materials of the present invention preferably have maximum polarisations of 0.12 C/m² or more, more preferably 0.14 C/m² or more, even more preferably 0.15 C/m² or more. The above parameters were obtained from displacement/electric field plot which was measured using a triangle waveform at a frequency of 10 Hz and room temperature. The electrodes of the tested samples were prepared using gold-sputtering. The diameter and thickness of electrodes were 2 mm and 100-200 nm, respectively.

As used herein, the term remnant polarisation refers to the residual polarisation of a sample when the electric field is reverted to 0 after charging, corresponding to the point where the hysteresis loop meets they axis of a displacement/electric field plot (see FIG. 1(d).

As used herein the term maximum polarisation refers to the highest polarisation achieved by a sample upon application of an electric field (see FIG. 1(d)).

In some embodiments the materials of the present invention have relative dielectric constants of 10 or higher when measured at 50° C. and at a frequency of 10 kHz. In further embodiments the materials of the present invention have relative dielectric constants of 12 or higher, preferably 15 or higher, more preferably 17 or higher, when measured at 50° C. and at a frequency of 10 kHz.

The molecular weight of the polymers used in the present invention is not particularly limited. However, high molecular weight polymers are generally preferred for use in the present invention. The fluropolymer of the present invention may have a molecular weight of greater than 100 kg/mol, preferably greater than 200 kg/mol, more preferably greater than 400 kg/mol, even more preferably greater than 500 kg/mol, most preferably greater than 600 kg/mol, In some embodiments the M,. of the fluoropolymer may be from 100 kg/mol to 1000 kg/mol, optionally 200 kg/mol to 800 kg/mol. The molecular weight of the polymers may be measured via any suitable method, such as gel permeation chromatography.

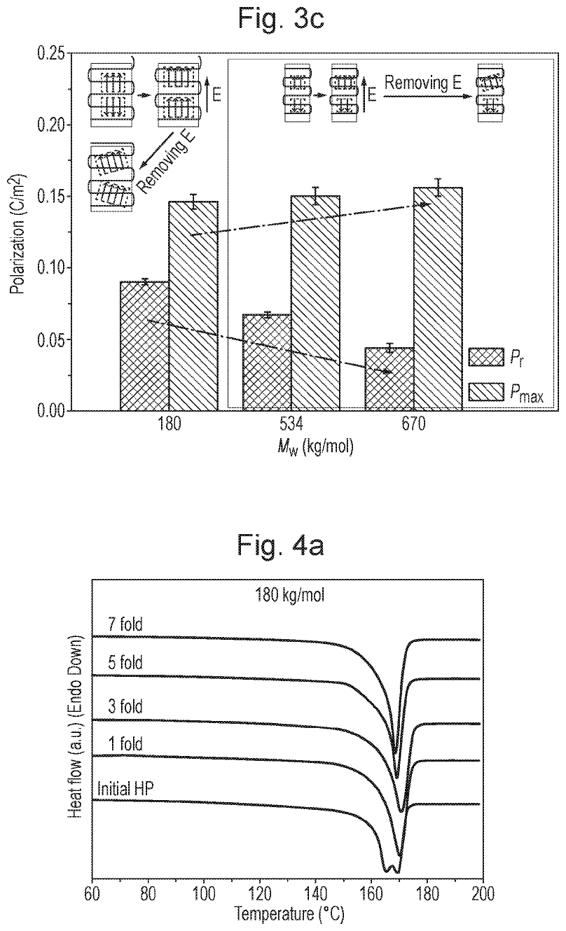

It has been shown that polymers with higher molecular weights yielded higher % β-phase when produced via the P&F method described below, see FIG. 2(b). Furthermore, materials produced according to the invention'have been shown to have increasing Pₘₐₓ and decreasing Pᵣ with increasing molecular weight M_{W}. Thus, higher polymers can provide higher U_{rec} (see FIG. 1(d) and FIG. 3).

Without wishing to be bound by the theory, the improved properties with higher M_{W} polymers are believed to partially result from the reduced average crystallite size of higher M_{W} polymers compared with low polymers, which is related to the reduced chain mobility with increasing M_{W}. In compositions according to the invention comprising low M_{W} polymers, it is considered that relatively larger-sized polar structures possess higher thermal stability.

The application of an external electric field induces the re-orientation of CF₂ dipoles and causes the regularization of the crystalline structure, [17] leading to the structure change to long-range ferroelectric order sections (see FIG. 3(c)). In compositions according to the invention, comprising polymers with high M_{W}, the small-sized polar structures are not stable due to the randomization of polarization induced by thermal activation, and despite the influence of external field, the polar structures are still relatively smaller (see FIG. 3(c)).

Consequently, more dipoles will reverse back upon the release of electric field, as characterized by the much lower Pᵣ 0.044 C/m² (FIG. 1(d) and FIG. 3(c)) compared to 0.090 C/m² in compositions comprising polymers with low M_{W} (FIG. 3(a) & (c).

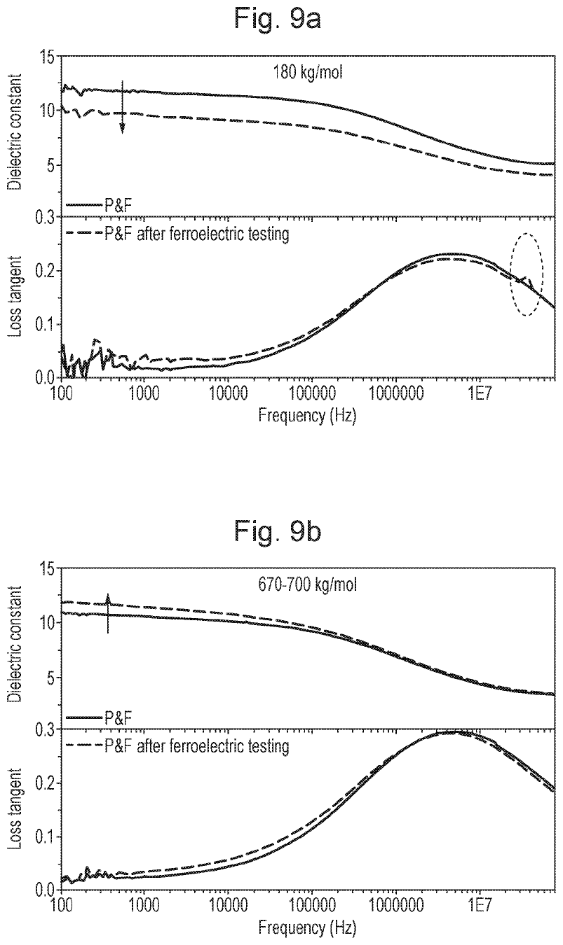

Compositions with high M_{W} (670-700 kg/mol) were also shown to exhibit lower piezoelectric (d₃₃) coefficients (−3.0/+4.2 compared to −10.8/+12.0 for compositions with lower M_{W} of 180 kg/mol) after the ferroelectric measurement up to 300 kV/mm, and no obvious piezoelectric resonance peak was detected in the frequency dependence of dielectric spectra of poled 670-700 kg/mol samples, while a small but clear one was seen in a poled 180 kg/mol sample (FIG. 9). This demonstrates the existence of readily reversible polar structures in P&F compositions with high M_{W}. However, lower M_{W} polymers may sometimes be preferable from the point of view of processability. Examples of suitable lower M_{W} ranges are from 50 to 500 kg/mol, preferably from 100 to 300 kg/mol.

As explained above, smaller crystallite size is preferable for samples according to the invention. Polymeric compositions according to the invention preferably have mean crystallite sizes of less than 20 nm, more preferably less than 10 nm, even more preferably less than 8 nm, yet more preferably less than 5 nm, most preferably less than 4 nm, wherein the crystallite size is calculated using X-ray diffraction (XRD) diffraction peaks at 20.0° and the Scherrer equation. The P&F method described below allows polymers with reduced crystallite size to be generated, thus providing the improved properties described above.

In an embodiment the present invention provides a dielectric material comprising more than 80 wt. % PVDF, preferably more than 95 wt. % PVDF, wherein the PVDF comprises greater than 90 mole percent, preferably greater than 95 mole percent of the vinylidene fluoride monomer unit, and Wherein greater than 85%, preferably greater than 90% of the crystalline region of the PVDF is β-phase.

In a further aspect of the above embodiment the % crystallinity of the PVDF is greater than 35%, preferably greater than 40%.

In a further aspect of the above embodiment the mean size of the crystallites is less than 10 nm, preferably less than 8 nm.

In a further aspect of the above embodiment the recoverable energy density U_{rec} of the material is 15 J/cm³ or greater, preferably 20 J/cm³ or greater when measured using an electric field of 800 kV/mm.

In a further aspect of the above embodiment the M_{W} of the PVDF is greater than 200 kg/mol, preferably greater than 500 kg/mol.

In an alternative embodiment the present invention provides a dielectric material comprising more than 95 wt. % of PVDF homopolymer, preferably more than 98 wt. % PVDF homopolymer, wherein greater than 85%, preferably greater than 90% of the crystalline region of the PVDF is β-phase.

In a further aspect of the above embodiment the M_{W} of the PVDF is greater than 200 kg/mol, preferably greater than 500 kg/mol,

In a further aspect of the above embodiment the % crystallinity of the PVDF is greater than 35%, preferably greater than 40%.

In a further aspect of the above embodiment the mean size of the crystallites is less than 10 nm, preferably less than 8 nm.

In a further aspect of the above embodiment the recoverable energy density U_{rec} of the material is 15 J/cm³ or greater, preferably 20 J/cm³ or greater when measured using an electric field of 800 kV/mm.

In an alternative embodiment the present invention provides a dielectric material consisting of PVDF, wherein greater than 85%, preferably greater than 90% of the crystalline region of the PVDF is β-phase and the % crystallinity of the PVDF is greater than 35%, preferably greater than 40%,

In a further aspect of the above embodiment the M_{W} of the PVDF is greater than 200 kg/mol, preferably greater than 500 kg/mol.

In a further aspect of the above embodiment the mean size of the crystallites is less than 10 nm, preferably less than 8 nm.

In a further aspect of the above embodiment the recoverable energy density U_{rec} of the material is 15 J/cm³ or greater, preferably 20 J/cm³ or greater when measured using an electric field of 800 kV/mm.

In a further aspect of any of the above described embodiments the material may be a film having a thickness which is between 10 nm and 1000 μm, preferably between 10 nm and 100 μm. In further aspects of the above described embodiments, the material may be film having a thickness which is between 1 and 100 μm, preferably between 1 and 50 μm.

The present invention also provides a process for producing fluoropolymer containing material, using a press-and-folding (P&F) technique. The sample used for the P&F technique is generally a polymeric sample, usually a film, which may be obtained by any conventional technique such as hot pressing (HP). The initial sample may be obtained from the melt by heating the polymer to above its melting temperature then cooling, e.g. via an extrusion process. The sample is then subjected to a “press-and-folding technique”, wherein the sample is folded upon itself at least once, followed by a pressing step. The folding and pressing steps are then repeated a number of times, in order to obtain a material according to the invention.

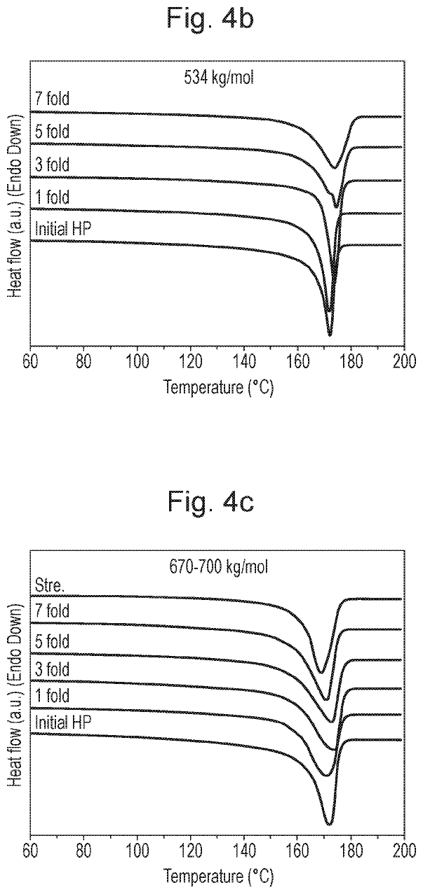

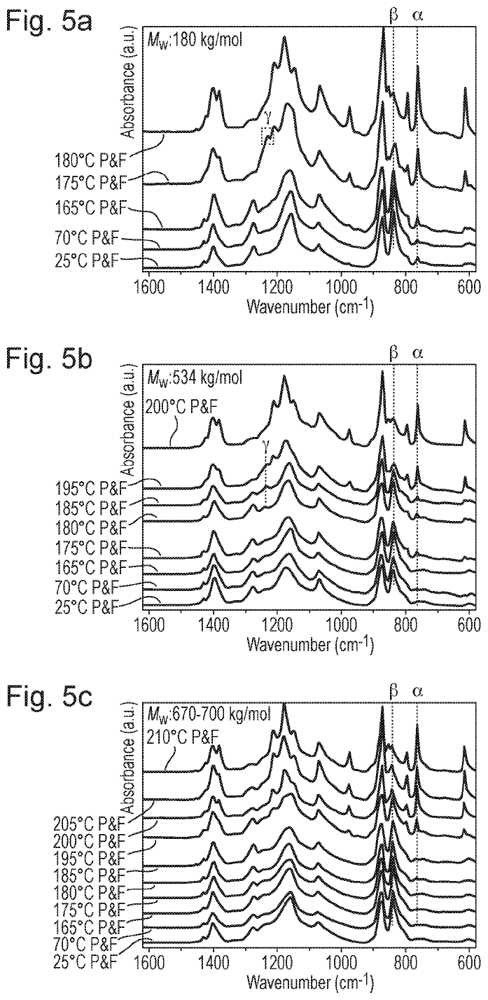

During P&F, a fine and discrete layered structure is generated, with the thickness of each layer decreasing with the number of P&F cycles applied (FIG. 1(b)). Hot pressed films with no folding are shown to contain predominantly a-phase, as confirmed by Fourier transform infrared spectroscopy (FTIR) (presence of characteristic peaks of α-phase at 764 cm⁻¹, 975 cm⁻¹ and 1212 cm⁻¹, and absence of the β/γ-characteristic peaks at 840 cm⁻¹) (FIG. 1(c)). However, the inventors surprisingly discovered that P&F can produce films containing ultrahigh β-phase content (˜95%, see (FIG. 1(c)) from commercially available PVDF pellets and powders, more than for any other reported method (max 85% by unidirectional/biaxial drawing, as highlighted by the horizontal shaded area in FIG. 1(c) [7], [14]) and a degree of crystallinity of 42±2%, typical of PVDF (FIG. 4 and Table 1). For comparison, stretched films which were solid-state drawn to failure at 100° C. and 10 mm/min, which were reported to be the optimum conditions for obtaining the P-phase in previous work [14], had β-phase content of ˜65% (see example 1 and the dashed line in FIG. 1(c)) and a degree of crystallinity of 43±2% (FIG. 5 and Table 1). The stretched films were shown to behave as normal ferroelectrics (see example 1).

Materials of the present invention showed increasing proportion of β-phase with increasing numbers of P&F steps (FIG. 1(c)). Further, the mean size of crystallites in the polymeric materials was shown to decrease with increasing numbers of P&F steps (Table 2). Both proportion of β-phase, and reduced crystallite size are associated with the improved properties shown by the materials of the present invention, as discussed above. Thus, the process of the present invention preferably comprises multiple cycles of pressing and folding steps. Preferably the process of the present invention comprises more than one, more preferably more than 2, even more preferably more than 4 and most preferably more than 6 cycles of press-and-folding steps. The number of press-and-folding steps is not particularly limited, but for practical reasons it does not generally exceed 20 press-and-folding cycles, more preferably it does not exceed 15 press-and-folding cycles, more preferably it does not exceed 10 press-and-folding cycles,

In some embodiments the sample is folded upon itself in one/all of the folding steps 1 to 8 times, preferably 1 to 5 times, more preferably 1 to 3 times.

In some embodiments the materials produced by the invention are films having a thickness which is 2000 μm or lower, preferably 1500 μm or lower, more preferably 500 μm or lower. In some embodiments the film has a thickness of 100 μm or lower, preferably 50 μm or lower. In some embodiments the film has a thickness of 10 nm or greater, optionally 1 μm or greater. In some embodiments the materials produced by the invention are films having a thickness which is between 10 nm and 2000 μm, preferably between 10 nm and 1000 μm. In a further embodiment the materials of the invention are films having a thickness between 1 and 1500 μm, preferably between 1 and 50 μm after at least 7 cycles of pressing and folding steps.

The pressing and folding steps of the present invention are preferably performed at a temperature (T_{fold}) which is around the melting temperature (Tₘ) of the polymer used. The T_{fold} used can impact the final crystal structure of the samples. Low T_{fold} (can be room temperature or lower) favours the transition to β-phase; moderately high T_{fold} can result in the incomplete transition from α-phase to β-phase and the formation of γ-phase in low M_{W} polymers, such as PVDF (FIG. 2 (a) & (b) and FIG. 5), If T_{fold} is too high, e.g. significantly above the melting temperature of the polymer, the polymer such as PVDF may maintain the non-polar α-phase. The term room temperature would be well understood by the skilled person, and may for example be used to describe a temperature in the range of 18 to 25° C.

Low T_{fold} and high T_{fold} herein refers to temperatures significantly lower or higher than the melting temperature of the polymer in question. In some embodiments at least one of the press-and-folding steps is performed at a temperature greater than or equal to 15° C. and less than or equal to 210° C., preferably greater than or equal to 25° C. and less than or equal to 210° C., more preferably greater than or equal to 70° C. and less than or equal to 185° C.

In some embodiments at least one of the press-and-folding steps is performed at a temperature within 40° C. of the Tₘ of the polymer used. In some embodiments at least one of the press-and-folding steps, is performed at a temperature greater than 40° C. below the Tₘ of the polymer used, and less than 10° C. above the Tₘ of the polymer used, preferably less than 5° C. above the Tₘ of the polymer used.

The temperature used in the folding step may optionally be the same or different from that used in the pressing step. In some embodiments the same temperature, for instance a temperature defined by the ranges above, is used for both pressing and folding steps in each P&F cycle. In a preferred embodiment the temperature of all press and fold cycles are performed in a temperature range as defined above. In some embodiments the pressing and folding steps may be performed at different temperatures. In some embodiments all of the pressing steps are performed at a temperature defined by any one of the ranges above.

In some embodiments one or more, preferably all, of the pressing steps are performed at a temperature of from 50° C. to 175° C., preferably 60° C. to 165° C. Using lower temperatures in this range increases internal strain, reduces average crystallite size and expands interchain distance, making the polar structure reversal easier and more stable. However, higher breakdown fields E_{b} were shown when using higher temperatures in this range. As U_{rec} depends on both E_{b} and maximum polarity, a balance must be struck with the temperature used. Thus, films with excellent properties are provided by pressing in the above temperature ranges.

The temperature of the polymeric sample may optionally be lowered between pressing and folding cycles. For example, the process of the invention may further involve a quenching step after at least one of the pressing and folding cycles. In some embodiments the quenching is performed in a liquid between 0 and 50° C., more preferably between 10 and 35° C., most preferably at between 15 and 25° C. In some embodiments the quenching liquid is water. In other embodiments a quenching step after at least one of the press and folding cycles may be performed at temperatures below 0° C., preferably below −190° C. In some embodiments the quenching liquid is liquid nitrogen.

In a preferred embodiment, the temperature of the sample is lowered after at least one of the pressing and folding cycles. Pressure is preferably maintained on the sample during the cooling. Maintaining pressure during cooling leads to better phase transformation to β-phase, and to the higher internal stress, preferred chain orientation and reduced crystallite size which contribute to the advantageous relaxor-like properties shown by materials according to the present invention.

In some embodiments, the internal strain of the polymeric material according to the present invention is greater than 2%, preferably greater than 4%, more preferably greater than 5%, yet more preferably greater than 6%.

In some embodiments, the internal stress of the polymeric material according to the present invention is greater than 30 MPa, preferably greater than 60 MPa, more preferably greater than 80 MPa, yet more preferably greater than 100 MPa.

In some embodiments, the β phase interchain distance in the polymeric material according to the present invention is greater than or equal to 4.30 Å, preferably greater than or equal to 4.40 Å, more preferably greater than or equal to 4.50 Å.

Internal stress, internal strain and interchain distance may be measures as set out in the Examples section.

The pressing step of the process of the present invention may optionally be performed at a pressure of greater than or equal to 10 MPa. The pressing step of the process of the present invention is preferably performed at a pressure of greater than or equal to 20 MPa, more preferably greater than 50 MPa. In an embodiment any/all of the pressing steps in the process of the present invention may be performed at a pressure greater than or equal to 20 MPa and less than or equal to 200 MPa, more preferably greater than or equal to 50 MPa and less than or equal to 180 MPa. In some embodiments, the pressure used in one or more of the pressing steps may optionally be higher than 180 MPa.

The material may optionally be held at the pressure and temperatures described above for 1 minute or more, preferably 3 minutes or more, during the pressing step.

For convenience the temperature (T_{fold}) and pressure used for each of the pressing and folding cycles may generally be the same. However, different temperatures and pressures may optionally be used for each of the cycles.

Any of the processes of the invention may comprise a final annealing step, wherein the polymeric sample is subjected to a final pressing step at a pressure as set out above, and at a temperature of 50 to 150° C., preferably 50 to 90° C., more preferably 50 to 70° C. In a preferred embodiment the annealing step is performed for at least 1 minute, preferably at least 5 minutes, more preferably at least 10 minutes, most preferably at least 15 minutes.

The beneficial properties shown by the materials of the present invention can be provided by the P&F method of the present invention. Without wishing to be bound by the theory it is believed that the pressure in the pressing step provides an anisotropic external field to produce preferred orientation of the polymer chains as in the case of tensile stress and electric field and leads to the formation of β-phase.

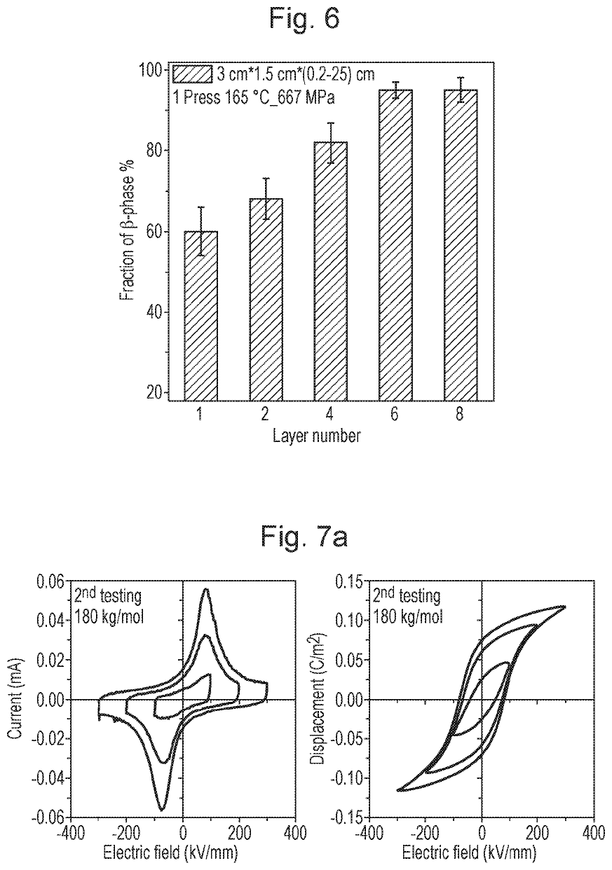

As shown in Example 2 (FIGS. 2(d) and 6)) the interfaces between the layers during processing are needed to provide the advantageous properties shown by materials according to the present invention. In addition to folding, these interfaces can also be provided by stacking multiple layers of polymeric sample. Thus, any of the folding steps in the P&F process described herein may optionally be substituted by a stacking step. For instance, the fluoropolymer material according to the invention may be formed by stacking multiple pressed fluoropolymer samples, such as films, and pressing them together. The number of stacked samples used in this method is preferably more than 4, more preferably more than 5.

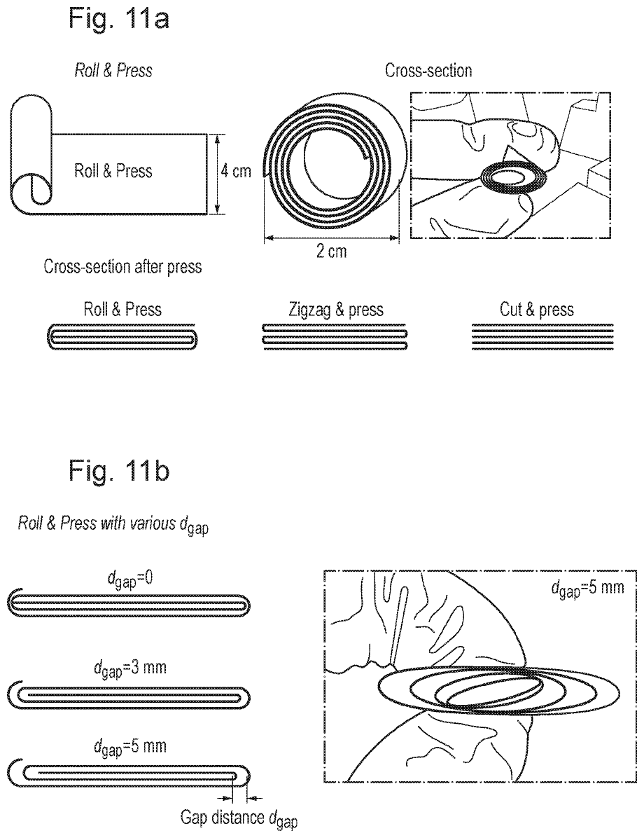

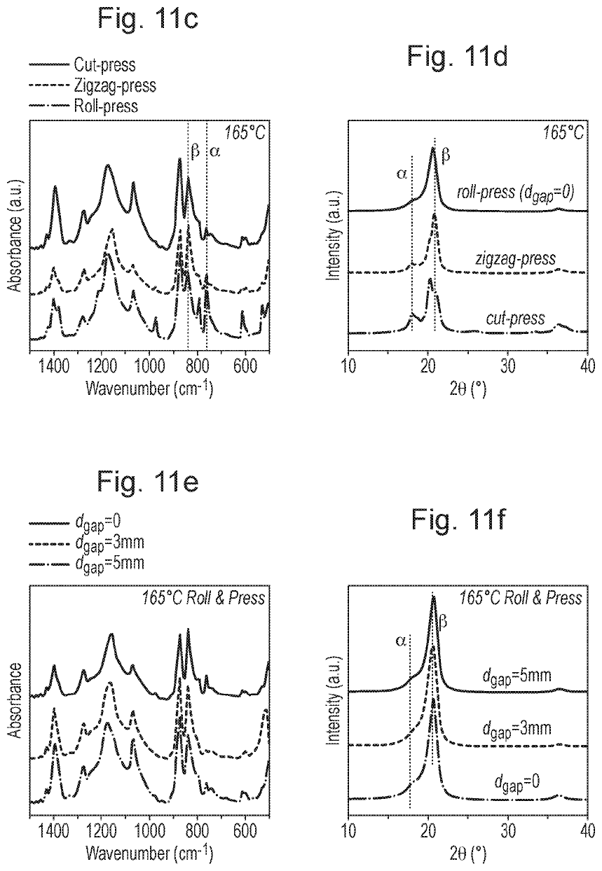

In a preferred embodiment, any of the folding or stacking steps in the above described methods may be substituted with a rolling step, wherein the polymeric sample is rolled up to provide a layered sample before pressing. In the rolling step the polymeric sample is rolled to provide a multi-layered tube having a spiral shaped cross section, which may be approximately cylindrical, e.g. as shown in FIG. 11(a) and (b). The rolled tube may be two or more layers thick, preferably 4 or more layers thick from the centre of the spiral to the outside of the spiral. The d_{gap} is defined as the maximum gap distance between the outermost layer and the next closest layer, obtained when the rolled sample is compressed. d_{gap} may optionally be from 0 mm to 20 mm. Alternatively, d_{gap} may be between 2 mm and 6 mm or from 3 mm to 5 mm.

The roll and press method discussed above can provide highly advantageous polymers, as the pressing of the continuous boundaries provided by the rolled sample lead to high internal strain. Further, as shown in Example 4 roll-pressed films provide higher β-phase PVDF after a single cycle of layering and pressing than by stacking and pressing, or by folding in a zigzag manner and pressing. In an embodiment high β-phase PVDF may be provided with a single roll and press cycle.

Preferred parameters such as temperature, pressure and fluoropolymer used in the press-and-folding method described above are also applicable to the stack and press and roll and press methods described above. The samples obtained from such stack and press and roll and press methods may optionally be further subjected to press-and-folding steps as described above.

Similarly, materials produced by the press-and-folding method, the stack and press method, and/or the roll and press method may be further stacked on top of one another and pressed together as an alternative to a press and fold step described above. Fluoropolymer materials for stacking may be produced separately, or may originate from a single sample which has been divided up via a suitable method, such as cutting.

For the industrial adoption of the P&F process, scale-up to a continuous production is desirable. A continuous production method based on the current processes for making croissant and puff pastry at an industrial scale could be used. For instance, the P&F process described herein may involve the following steps: extrusion, for example by using a machine like a dough sheeter to form a sheet; folding, for example by using a “sandwich folding machine”; and pressing, for example with a rolling unit which compresses the sheet between a rolling unit and a surface and/or further roller. In some embodiments multiple folds are obtained at the end of the process with a unit called a folding station. In this process, the rolling unit fulfils the pressing function of the P&F process. The “dough sheeter” is a machine which extrudes material into a flattened sheet, which is preferably of uniform thickness. The “sandwich folding machine” is a machine which passes a length of sheet through an opening, where the opening is configured such that the sheet is folded along its width as it passes through the opening in the longitudinal direction. For example, the sandwich folding machine may comprise a conveyor belt and an opening with angled sides wherein the sheet to be folded is transported through the opening via the conveyor belt, and the angled sides contact the edges of the sheet folding them towards the centre of the width sheet. The folding station is a unit configured to further fold the sample upon itself Any of the pressing steps described herein may be performed by compressing the sample between a roller and a surface and/or another roller.

An embodiment of the present invention includes a material obtainable via any of the processes described above. The novel polymeric materials described herein may be produced by the methods described above.

The present invention also provides a device comprising a material produced by any of the methods described herein, or comprising any of the novel materials described herein. In a preferred embodiment the device is a dielectric capacitor.

The publications, patent publications and other patent documents cited herein are entirely incorporated by reference. Herein, any reference to a term in the singular also encompasses its plural. Where the term “comprising”, “comprise” or “comprises” is used, said term may be substituted by “consisting of”, “consist of” or “consists of” respectively, or by “consisting essentially of”, “consist essentially of” or “consists essentially of” respectively. Any reference to a numerical range or single numerical value also includes values that are about that range or single value.

### EXAMPLES

The following are Examples that illustrate the present invention. However, these Examples are in no way intended to limit the scope of the invention.

### Production and Characterisation of Films Using the Press-and-Folding (P&F) Method

Materials:

Polyvinylidene fluoride (PVDF) pellets or powders with different molecular weight (M_{W}) 180 kg/mol and 534 kg/mol were purchased from Sigma Aldrich Chemical Co. PVDF with M_{W} of 670-700 kg/mol (Solef® 6020) was purchased from Solvay S.A.

Film Preparation:

Initial hot pressed (HP) films were prepared by pressing the PVDF pellets or powders described above using a Collin hot press P300E (Germany) at 180° C. and 100 bar for 5 minutes followed by cold water quenching to room temperature.

Unless otherwise specified P&F films according to the present Examples were prepared as follows: The initial films were first folded and cold pressed at 240 bar. The temperature was then increased from ambient temperature to 165° C. The folded films were then held for 5 minutes under the conditions of 165° C. and 240 bar, followed by cold water quenching with the pressure maintained.

These steps were then repeated an arbitrary number of es in order to obtain P&F films according to the present invention.

Characterisation Methods:

Fourier transform infrared spectroscopy (FTIR) (Tensor 27, Bruker Optik GmbH, Ettlingen, Germany) and wide-angle X-ray diffractometry (XRD) (X′Pert Pro, PANalytical, Almelo, The Netherlands) were used to characterize the crystalline structure of the samples.

The % β-phase of the crystalline regions (F(β)) was determined using the following equation:

$$F ( β ) = \frac{{A}_{β}}{1.26 {A}_{α} + {A}_{β}} \times 100 \%$$

where Aα and A_{β} correspond to the measured absorbance at 766 cm⁻¹ and 840 cm⁻¹ obtained in the FTIR data [6]. FTIR was also used to determine the chain conformations of samples.

The interchain distance was calculated using Bragg's law:

$$2 * d * sin θ = n * λ$$

wherein λ is the wavelength, θ is the diffraction angle, and d is the interchain distance.

The local internal stress inside the film at different temperatures was approximately evaluated assuming linear-elastic behavior and using the equation σᵣ=ε* K and plotted in FIG. 15(c), where σᵣ is the internal stress, ε is the lattice strain and K is bulk modulus. The internal lattice strain ε is then calculated by the change of interchain distance,

$$ɛ = \frac{{d}_{1} - {d}_{0}}{{d}_{0}} ,$$

in which d₀ is the β phase interchain distance of typical solid state drawn films (4.25 Å), while d₁ is the interchain distance obtained from the diffraction peak of β phase using Bragg's Law. The bulk modulus K used here was 2 GPa,

Raman spectra between 1000-100 cm⁻¹ was measured by a Renishaw inVia™ Raman microscope with a 785 nm laser, 1200 lines mm⁻¹ grating and 50×objective lens (Renishaw, UK).

Thermal analysis was performed using differential scanning calorimeter (DSC) (DSC 25, TA Instruments, Asse, Belgium) with a heating/cooling rate of 10° C./min.

The degree of crystallinity (X_{c}) is calculated using the following equation:

$${χ}_{c} = \frac{Δ {H}_{f}}{Δ {H}_{f}^{*}} \times 100 \%$$

where ΔH_{f} and ΔH*_{f} are the melting enthalpies of the tested samples and the perfectly crystalline PVDF, respectively. ΔH_{f} is obtained from the integration of the melting peak and ΔH*_{f} is 104.6 J/g [6].

The morphology of samples was characterized using a scanning electron microscopy (SEM) (FEI Inspect-F, Hillsboro, Oreg., USA) and atomic force microscopy (AFM) (NT-MDT, Ntegra systems, Russia),

The temperature and frequency dependence of the dielectric properties were characterized using a LCR meter (4284A, Agilent, Santa Clara, Calif.) and Precision Impedance Analyser (4294A, Agilent, Santa Clara, Calif.), respectively.

The ferroelectric hysteresis loops were obtained using a ferroelectric tester (NPL, Teddington, UK) using a triangle waveform at room temperature and 10 Hz. The tester could only generate a maximum voltage of 10 kV, so the folded samples were unfolded to produce an appropriate thickness (10-20 μm). Electrodes with thickness of 100-200 nm and diameter of 2 mm for electric measurement were prepared via gold-sputtering.

### Example 1: Comparison of P&F Films with Stretched and HP Films

Press and folded, hot pressed films were produced as discussed above, using the PVDF with M_{W} of 670-700 kg,/mol, and folded at a temperature of 165° C. Stretched films were solid-state drawn to failure at 100° C. and 10 mm/min, which was reported to be the optimum conditions for obtaining the β-phase in previous work [14].

Cross-sectional SEM images of P&F samples after different numbers of folding cycles are shown in FIG. 1(b). A fine and discrete layered structure was generated during P&F.

The evolution of the crystalline phase was shown by the FTIR absorbance spectrum (FIG. 1(c)). The initial hot pressed (HP) films mainly crystallized into α-phase with characteristic peaks at 764 cm⁻¹, 975 cm⁻¹ and 1212 cm ⁻¹ highlighted by asterisks and transformed to about 95% β-phase after seven folding cycles. The horizontal shaded area indicates the reported values of fraction of β-phase in commonly stretched PVDF films, and the dashed line represents the fraction of β-phase for the stretched film produced in this example. The fraction of β-phase can clearly be seen to increase with increasing number of P&F steps.

A comparison of electric energy storage properties of P&F and stretched films was also performed. This comparison included ferroelectric hysteresis loops, schematic calculations of stored energy of ferroelectric materials and the recoverable energy density U_{rec} and the energy efficiency η of P&F and stretched films (see FIG. 1(d)).

The content of β-phase for stretched films was shown to be ˜65% (indicated by the dashed line in FIG. 1(c)) with a degree of crystallinity of 43±2% (FIG. 4 and Table 1). The stretched films behave as normal ferroelectrics, as evidenced by the obvious current switching peaks (FIG. 1(d)) and high remnant polarization (Pᵣ) (0.072 C/m²), From the schematic diagram of stored energy in ferroelectrics (FIG. 1(d)), it can be seen that a lower Pᵣ, a higher maximum polarization (Pₘₐₓ) and a higher E_{b} are favourable in order to obtain higher recoverable energy density U_{rec}. The P&F samples show four current peaks with double hysteresis loops at low electric fields (<240 kV/mm) and an extremely high E_{b}, 800 kV/mm. The Pᵣ and Pₘₐₓ were 0.044 and 0.16 C/m², respectively. All of these parameters contributed to a high U_{rec} of 29 J/cm³. A high energy efficiency (η) of ˜55% was obtained, compared to the stretched film (˜25%).

### Example 2: Alternative Processing Conditions: Stacking and Pressing

A variety of films were produced using the processes set out below. Unless otherwise specified, all of the following films were produced using PVDF having M_{W}: 670-700 kg/mol. Fraction of β-phase for all of these films is shown in FIG. 2(d) and FIG. 6.

Films with similar thickness (˜0.2-0.25 cm), but with different numbers of layers: a film with a single layer and a film with 6 layers, were produced under the same pressing conditions, 165° C. and 240 bar and cold water quenching in the presence of pressure. Both films were subjected to three different pressures—120 MPa (5 cm×5 cm), 667 MPa (3 cm×1.5 cm) and 3000 MPa (1 cm×1 cm)—varied via controlling the area of samples (see FIG. 2(d).

Films with the same dimensions (3 cm×1.5 cm×(0.2-0.25) cm), but composed of different layers: a film with a single layer, a film with 2 layers, a film with 4 layers, a film with 6 layers and a film with 8 layers, were pressed at the same condition (1 press at 165° C., 240 bar, 5 min, followed by cold water quenching in the presence of pressure).

It was found from FTIR data that for any applied pressure, the six-layers film possesses much larger fraction of β-phase compared to the single-layer films (FIG. 2(d)), which demonstrates that the PVDF-PVDF layers promote the formation of β-phase. This is also supported by the increase of the fraction of β-phase (from 60% to 80%) with increasing the number of layers (from one to four) for films with the same dimensions (3 cm×1.5 cm×(02-0.25) cm) and pressed at the same condition (1 press at 165° C., 240 bar, 5 min, followed by cold water quenching in the presence of pressure). The phase transition saturated for films with six or more layers (˜95%) (FIG. 6). This highlights that the PVDF-PVDF interface is essential for the development of exceptional properties (ultrahigh β-phase content and high energy storage density) provided by the films of the present invention (see FIG. 1).

Moreover, atomic force microscopy (AFM) images reveal the change of morphology during folding, from large grains (˜1 μm in diameter) in the initial HP films to small granular structure (˜150 nm in diameter) after P&F (see FIG. 2(c)).

Thus, the application of pressure to a layered structure of PVDF, which may be obtained via folding or stacking during the processes described herein, is shown to produce advantageous, high β-phase samples with the exceptional properties described herein.

### Example 3: Effect of T_{fold} and M_{W} on Polymer Structure and Properties

PVDF samples with M_{W}: 180 kg/mol, 534 kg/mol, and 670-700 kg/mol, which exhibit similar Tₘ (169-172° C.), were used to create polymeric films using the P&F process described above at a variety of different T_{fold}. FTIR data after 1 press-and-folding step, 3 press-and-folding steps, 5 press-and-folding steps and 7 press-and-folding steps arc shown in FIG. 2(a).

Sample Composition

Previous works suggested the formation of another polar phase, γ-phase, after high temperature (around Tₘ) treatments [15], [16]. FIG. 2(a) indicates the formation of γ-phase in PVDF with low M_{W} at higher T_{fold} (denoted by the γ-characteristic band at 1234 cm⁻¹) and the preference of high M_{W} for the transition to β-phase.

All of the PVDFs used were shown to transform to β-phase with high β-phase content (90-95%) regardless of M_{W}, but require an appropriate T_{fold} (FIG. 2(b) and FIG. 5). The γ-phase, with mixed components of α- and β-phase, forms in PVDF with M_{W} of 180 kg/mol P&F at 175° C. and 534 kg/mol P&F at 180° C. (FIG. 2(a)), evidenced by the exclusive characteristic FTIR band (1234 cm⁻¹), being consistent with the reported work of a phase transition from α- to γ-phase in PVDF (M_{W}: 180 kg/mol) in the temperature range of 167-180° C. and under a minimum applied pressure of 200 kPa [16]. The β-phase becomes more dominant during P&F with increasing M_{W} (FIG. 2(a) & (b)), PVDF with M_{W} of 670-700 kg/mol still showed ultrahigh content of β-phase (˜95%) even after P&F at 180° C. (˜10° C. higher than Tₘ) (FIG. 2(a) inset), and no traces of γ-phase were detected during P&F at 195° C. (˜20° C. higher than Tₘ).

The phase evolution of PVDF with T_{fold} during P&F is explained in FIG. 2(b). Firstly, β-phase (with ultrahigh content) forms during P&F even at room temperature. Secondly, the formation of β-phase prefers high M_{W}, as demonstrated by the relatively higher average content (˜95% in 534 and 670-700 kg/mol P&F samples while only ˜90% in 180 kg/mol P&F samples). Finally, a balance exists regarding to T_{fold}: low T_{fold} favours the transition to β-phase (<Tₘ and as low as room temperature); moderately high T_{fold} can result in the incomplete transition from α- to β- and the formation of γ-phase in low M_{W} PVDF; and the even higher T_{fold} which is significantly above the Tₘ can make PVDF maintain the non-polar α-phase.

Sample Properties

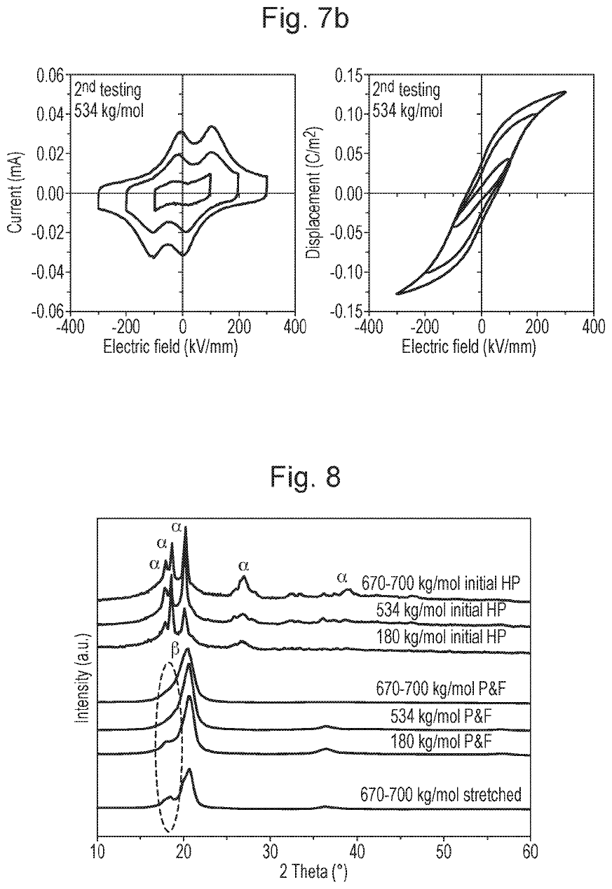

The ferroelectric current-polarization-electric field (I-P-E) characteristics were measured under various electric fields at room temperature and 10 Hz (FIG. 3). The raw 1-E, curves, in which the presence of ferroelectric switching peaks can be easily identified, are most useful in demonstrating the ferroelectric properties of a sample, Not all of the P&F samples showed relaxor-like ferroelectric behaviour (FIG. 3(a)); the higher M_{W} polymers (534 and 670 kg/mol) showed four current peaks (FIG. 3(b) and FIG. 1(d)), However, the P&F polymer with lower M_{W} (180 kg/mol) showed four current peaks at electric fields lower than 200 kV/mm which merged into two current peaks at 300 kV/mm (FIG. 3(a)), which indicates the existence of field-induced polar structural changes in P&F samples with low M_{W} (180 kg/mol). This was further demonstrated by the second ferroelectric hysteresis loops (FIG. 7), which were shown to be different from those obtained on pristine films (FIG. 3(a) and (b)), demonstrating that the structural changes are not reversible.

X-ray diffraction (XRD) studies were performed in order to gain insight into field-induced structural changes in the P&F samples (FIG. 8). The XRD data shows the reduction of the mean size of crystallites, from ˜20 nm in the initial HP films to ˜5 nm after the P&F treatment (Table 2). The average size of crystallites in P&F samples decreased from 6 nm to 3.5 nm with increasing M_{W} from 180 to 670-700 kg/mol (Table 2), which can be related to the reduced chain mobility with increasing M_{W}.

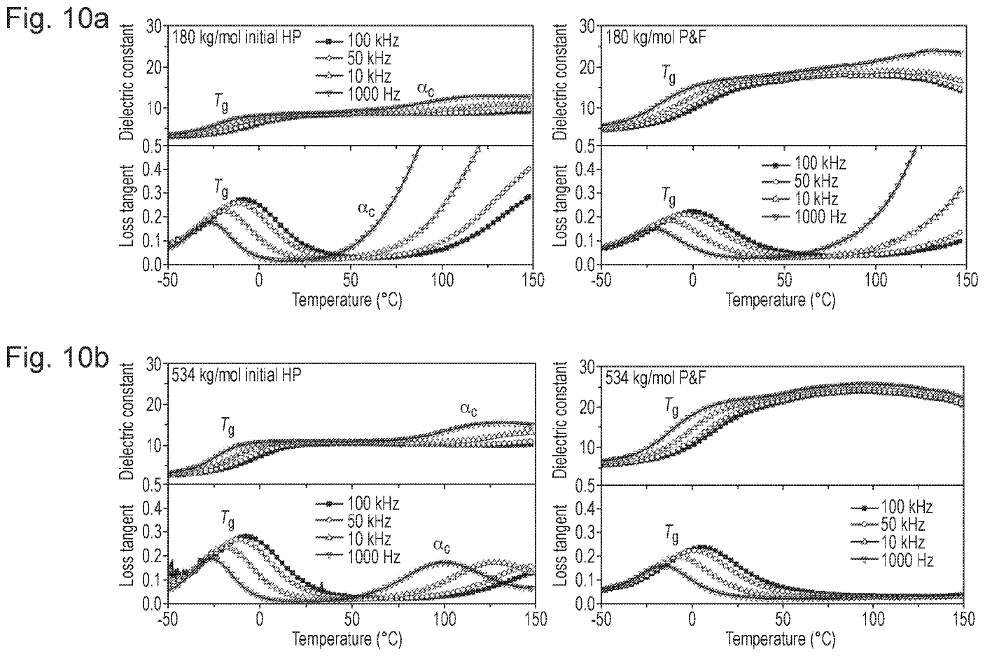

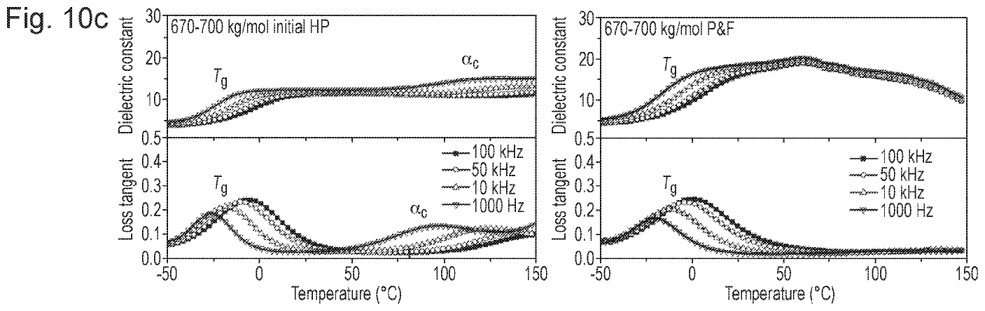

At high temperatures, the small-sized polar structures in the P&F samples were shown to suffer severe thermal fluctuation and become more unstable, as highlighted in the temperature dependence of dielectric permittivity (FIG. 10), where the dielectric constant showed a declining trend at temperature above 50° C.

TABLE 1
The melting temperature (Tₘ) and crystallinity of initial HP and P&F
PVDF films.
The enthalpy value for a 100% crystalline PVDF is 104.6 J/g. [14]

| Samples | Tₘ [° C.]^{a)} | Crystallinity |
|---|---|---|
| 180 kg/mol initial HP | 164.9/169.4 ± 1 | 50 ± 2% |
| 180 kg/mol 1 fold | 167.0 ± 1 | 51 ± 1% |
| 180 kg/mol 3 fold | 166.8 ± 1 | 52 ± 1% |
| 180 kg/mol 5 fold | 168.9 ± 2 | 50 ± 2% |
| 180 kg/mol 7 fold | 168.6 ± 1 | 51 ± 1% |
| 534 kg/mol initial HP | 172.2 ± 1 | 55 ± 2% |
| 534 kg/mol 1 fold | 171.9 ± 1 | 51 ± 2% |
| 534 kg/mol 3 fold | 174.0 ± 1 | 52 ± 2% |
| 534 kg/mol 5 fold | 174.4 ± 2 | 48 ± 3% |
| 534 kg/mol 7 fold | 173.7 ± 1 | 47 ± 2% |
| 670-700 kg/mol initial HP | 171.7 ± 1 | 47 ± 1% |
| 670-700 kg/mol 1 fold | 171.1 ± 1 | 45 ± 2% |
| 670-700 kg/mol 3 fold | 173.2 ± 2 | 44 ± 2% |
| 670-700 kg/mol 5 fold | 170.6 ± 2 | 43 ± 1% |
| 670-700 kg/mol 7 fold | 173.7 ± 1 | 42 ± 2% |
| 670-700 kg/mol stretched | 169.0 ± 2 | 43 ± 2% |

^{a)}Melting temperature

The folded samples show similar melting temperatures compared to the initial HP materials (no folding) (FIG. 4). As for the crystallinity, the P&F treatments hardly changed it for films with M_{W} of 180 kg/mol. However, the P&F films with higher M_{W} showed crystallinity of ˜43% and 49%, being lower compared to ˜47% and 55% of initial HP films with M_{W} of 670 and 534 kg/mol, respectively (Table 1).

TABLE 2
The XRD data for initial HP and P&F.
The size of crystallites was calculated using diffraction peaks at about
20.0° and Scherrer equation. A decrease in the mean size of crystallites
is observed after P&F.

| | | FWHM^{a)} | |
|---|---|---|---|
| | 2 Theta | corresponding | |
| | corresponding | to the | |
| | to the | reflections | |
| | reflections | of (110)α | Mean size |
| | of | and/or | of |
| | (110)_{α} and/or | (110)/(200)β | crystallites |
| Samples | (110)/(200)_{β}[°] | [rad] | [nm] |
| 180 kg/mol initial HP | 20.1 | 0.36 | 22 |
| 534 kg/mol initial HP | 20.2 | 0.39 | 21 |
| 670-700 kg/mol initial HP | 20.1 | 0.41 | 20 |
| 180 kg/mol 7 fold | 20.8 | 1.32 | 6 |
| 534 kg/mol 7 fold | 20.7 | 1.87 | 4 |
| 670-700 kg/mol 7 fold | 20.6 | 2.25 | 3.5 |
| 670-700 kg/mol stretched | 20.6 | 0.78 | 10 |

^{a)}Full width at half maximum

### Example 4: Alternative Processing Conditions: Rolling and Pressing

A hot-pressed PVDF film was prepared by compressing 4.0g of PVDF powder with M_{W}: 670-700 kg/mol at 220° C. and 150 kN for 5 minutes followed by cooling with cold water down to 50° C. under constant pressure. A round film with diameter of ˜10 cm and thickness of ˜300-400 μm was obtained. The film was rolled into a roughly circular tube (see FIG. 11(a) and (b)) to create continuous boundaries (11 boundaries).

The tube was then compressed at 375 MPa and 165° C., and annealed at this temperature for 10 minutes before cooling to 50° C. with cold water, whilst under pressure. The fraction of β phase in the one-step roll-pressed film reached ˜80%, which is much higher than corresponding zigzag-pressed (˜71%) and cut-pressed (˜46%) films after a single round of layering and pressing, as demonstrated by the FTIR and XRD results in FIG. 11(c) and (d).

As discussed below, press and folding at low temperature prompts the accumulation of internal stress, leading to stabilized polar nanostructure and higher U_{rec}, while P&F at high temperature enhances E_{b}. The compression of a boundary edge, e.g. as provided by folding or rolling the samples, during the compression step also contributes to the high internal stress which provides stabilized polar nanostructure. The roll and press processing method described above creates continuous boundaries and so can achieve the P&F induced advantages in only one step, as shown in FIG. 11(a).

The roll-pressed film exhibited higher internal strain than its counterparts, as shown in FIG. 11(d). This is believed to be due to the constraining effect on the boundaries, which strongly reduces the chain mobility and the constrained film flow during the pressing.

Gap distances of 3 mm (d_{gap}=3 mm) and 5 mm (d_{gap}=5 mm) were used to improve the flowability while maintaining the constraining effect on boundaries, as shown in FIG. 11(b). Of the three d_{gap} values tested, a maximum β-phase % of 93% was obtained in the roll and press (d_{gap}=3 mm) films, indicating that a balance between the constraining effect and the flowability was achieved, which maximized the phase transformation.

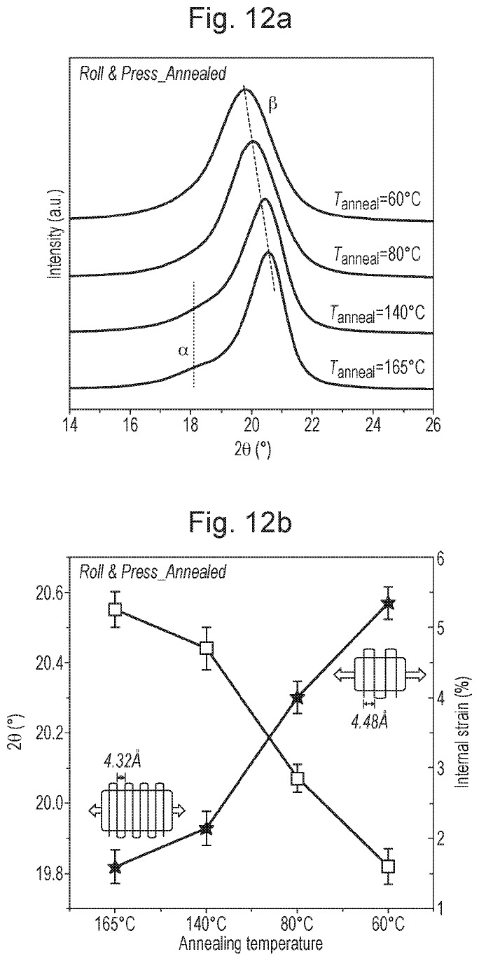

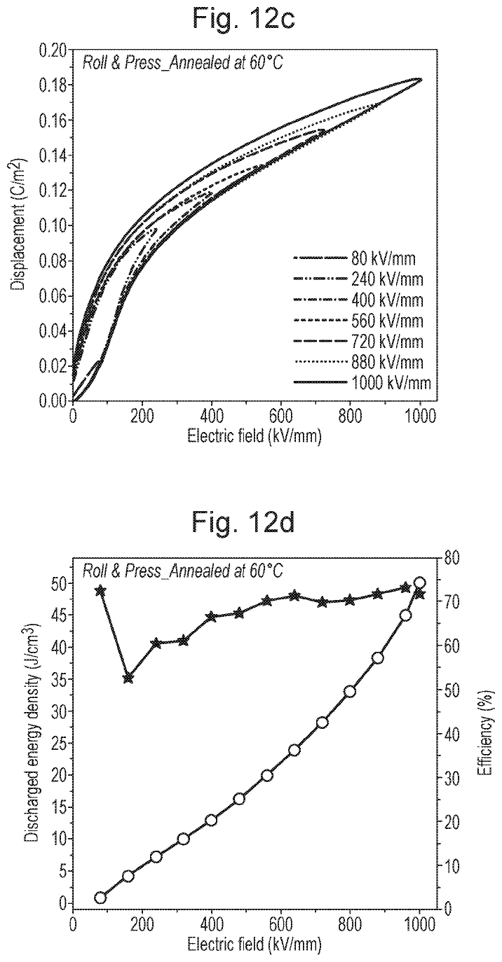

As low processing temperatures were shown to be favourable for accumulating internal strain in the samples, roll and press films with d_{gap} of 3 mm were further annealed in a high pressure step at low temperatures of 60, 80 and 140° C. for 15 minutes respectively to facilitate the internal strain build up after roll-pressing at the higher temperature of 165° C. for 1 minute. This annealing facilitated further phase transformations. As evidenced by XRD spectra in FIG. 12(a) and (b), greater than 98% p phase with an internal lattice strain of 5% was achieved in the 60° C. annealed roll-pressed film with d_{gap} of 3 mm. The interchain distance was broadened to 4.48 Å and giant energy storage density U_{rec} of 50.1 J/cm³ was achieved at the breakdown field of 1000 kV/mm with efficiency of 72% (FIG. 7(d)), which is the highest ever obtained for any dielectric polymer and composites and exceeds even that of press and folded films.

### Example 5: Press and Fold Induced Internal Strain and In-Plane Orientation

A hot-pressed PVDF film with Mw: 670-700 kg/mol was prepared as in Example 4, by compressing 4.0 g of PVDF powder at 220° C. and 150 kN for 5 minutes followed by cooling with cold water down to 50° C. under constant pressure. The films were subjected to the P&F procedure described above, except that a force of 300 kN was used for the pressing steps, and the pressure was maintained at 165° C. for 10 minutes before cooling to 50° C. with cold water whilst maintaining the pressure. Additionally, the films were sprayed with a polytetrafluorethylene (PTFE) mould release agent prior to each press and fold step in order to facilitate unfolding. The samples were subjected to 1 to 6 cycles of pressing and folding, followed by unfolding into a single layer with thickness of around 5-10μm for characterization.

The development of relaxor-like ferroelectric behaviour in P&F PVDF films was shown to be dependent on the structure evolution during the P&F process, as schematised in FIG. 13(a). FTIR spectra (FIG. 14(a) demonstrates the phase transformation from α to β phase. XRD spectra were also taken to provide more information on the morphology (FIG. 13(e) and (f)). Reduced crystallite size was shown for each cycle of P&F (FIG. 14(b)). This is believed to largely result from accumulated high pressure with increasing P&F cycles.

It was also shown that both the peak belonging to (110)/(200)_{β} crystal plane at 20.88° and the peak belonging to (100)_{α} crystal plane at 18.02° continuously shift toward lower angles (20.44° and 17.78° , respectively) after 6 cycles of P&F, implying that in-plane internal strain was introduced into the press-folded films. Raman spectra of the PVDF film with different P&F cycles were also acquired, (FIG. 14(c) and (d)). Similarly to the XRD peak shift, the Raman peak of both a and p phase experienced an obvious shift to higher Raman shift as the internal stress shortened the bond length and more energy were needed to activate these molecular vibration.

The internal strain is believed to stretch the polymer chain and expanded the intermolecular chain distance, making both the polarization and depolarization easier to be achieved under an applied field. It is also believed to induce certain in-plane orientation, as indicated by the disappearance of the β phase diffraction peak at 36.5° and 56.1° after 6 P&F cycles, which belong to (020)/(101) and (221) crystal plane respectively. The XRD spectra between 45° and 60° are enlarged and presented in FIG. 13(f). The intensity of peak (221)_{β} at 56.1° first increased and reached the maximum at three P&F cycles, which is considered to results from the increased β phase content in the P&F films. It then started to decrease and the peak became broad as the film was further press-folded. This is consistent with the oriented lamellae morphology observed in the cross-section of the PVDF films P&F 6 times, as shown in FIG. 13(b). Dipoles in these well-aligned edge-on lamellaes are parallel to the electric field and therefore are easier to follow the applied field, which is desirable for energy storage.

### Example 6: Effect of Temperature on Polymer Structure in Press and Fold Films

P&F films were produced as in Example 5, except that alternative temperatures of between 60° C. to 165° C. were used in the pressing steps. 6 cycles of P&F were used for all samples.

As discussed above, the constraining effect provided by the press and fold and roll and fold processes helps to achieve and maintain the favorable microstructure and properties in P&F films. In order to obtain higher internal stress in the P&F film, lower P&F temperatures were applied so to reduce the polymer chains mobility. As revealed by XRD results, all the P&F films, from 60° C. to 165° C., experienced an α to β phase transformation, with a ˜98% β phase content in the 6-fold films. However, variations in crystallite size and internal strain exist, as demonstrated by the peak broadening and shift in the XRD spectra in FIGS. 15(a) and 15(b). The average crystallite size was shown to reduce from 4.6 nm to 3.3 nm by lowering the P&F temperature form 60° C. to 165° C. Further, the β phase characterization peak at 20.88° monotonically shifts from 20.44° , in 165° C. P&F film, to 19.54° , in 60° C. P&F film, as a result of higher internal stress induced by the stronger constrain effect at lower temperature. Consequently, the interchain distance expanded from 4.35 Å to 4.53 Å (compared to 4.25 Å for uniaxial stretched films) as the P&F temperature is decreased from 165° C. to 60° C., making the polar structure reversal easier and more stable. As shown in FIG. 15(c), the internal stress in the 6-fold film P&F at 60° C. is ˜135 MPa, which is over 3 times of that in the 165° C. P&F films.

The 6-fold 60° C. P&F films were left for one year at room temperature and XRD spectra were taken. These were shown to be almost identical to those fresh film, with a decrease in the internal strain of only around 4.1%,

### REFERENCES

[1] X. Hao, Journal of Advanced Dielectrics 2013, 03, 1330001.
[2] T. Christen, M. W. Carlen, J. Power Sources 2000, 91, 210.
[3] H. Sun, X. Fu, S. Xie, Y. Jiang, H. Peng, Adv. Mater. 2016, 28, 2070; A. Burke, Electroehim. Acta 2007, 53, 1083.
[4] Z.-M. Dang, J.-K. Yuan, S.-H. Yao, R.-J. Liao, Adv. Mater. 2013, 25, 6334.
[5] A. J, Lovinger, Science 1983, 220, 1115; N. Meng, R. Mao, W. Tu, X. Zhu, R. M. Wilson, E. Bilotti, M. J. Reece, Polymer 2016, 100, 69.
[6] N. Meng, X. Zhu, R. Mao, M. J. Reece, E. Bilotti, Journal of Materials Chemistry C 2017, 5, 3296.
[7] J. Gomes, J. S. Nunes, V. Sencadas, S. Lanceros-Mendez, Smart Mater. Struct. 2010, 19, 065010.
[8] J. Wu, A. Mahajan, L. Riekehr, H. Zhang, B. Yang, N. Meng, Z. Zhang, H. Yan, Nano Energy 2018, 50, 723.
[9] Q. M. Zhang, V. Bharti, X. Zhao, Science 1998, 280, 2101.
[10] V. Bobnar, B. Vodopivec, A. Levstik, M. Kosec, B. Hilczer, Q. M. Zhang, Macromolecules 2003, 36, 4436.
[11] H. Xu, Z. Y. Cheng, D. Olson, T. Mai, Q. M. Zhang, G. Kavamos, Appi. Phys. Lett. 2001, 78, 2360.
[12] F. Guan, L. Yang, J. Wang, B. Guan, K. Han, Q. Wang, L. Zhu, Adv. Funct. Mater. 2011, 21, 3176.
[13] Y. Tian, L. Jin, H. Zhang, Z. Xu, X. Wei, E. D. Politova, S. Y. Stefanovich, N. V. Tarakina, 1. Abrahams, H. Yan, Journal of Materials Chemistry A 2016, 4, 17279.
[14] N. Meng, R. Mao, W. Tu, K. Odolczyk, Q. Zhang, E. Bilotti, M. J. Reece, Polymer 2017, 121, 88.
[15] W. Li, Q. Meng, Y. Zheng, Z. Zhang, W. Xia, Z. Xu, Appl. Phys. Lett. 2010, 96, 192905.
[16] S. J. Kang, Y. J. Park, J. Y. Hwang, H. J. Jeong, J. S. Lee, K. J. Kim, H. C. Kim, J. Huh, C. Park, Adv. Mater. 2007, 19, 581.
[17] T. Furukawa, Phase Transitions 1989, 18, 143.

1. A dielectric material comprising a fluoropolymer, wherein the fluoropolymer comprises poly(vinylidene fluoride) (PVDF), wherein greater than 85% of the crystalline region of the PVDF is β-phase.

2. The dielectric material of claim 1 wherein the fluoropolymer is poly(vinylidene fluoride), preferably poly(vinylidene fluoride) homopolymyer.

3. The dielectric material according to claims 1, wherein greater than 90% of the crystalline region of the fluoropolymer is β-phase, preferably wherein greater than 95% of the crystalline region of the fluoropolymer is β-phase.

4. The dielectric material to claim 1, wherein, the % crystallinity of the fluoropolymer is greater than 30%, when measured using differential scanning calorimetry (DSC), preferably wherein the % crystallinity of the fluoropolymer is greater than 35%, more preferably greater than 40%, when measured using differential scanning calorimetry (DSC). 5. The dielectric material according claim 1, wherein the recoverable energy density U_{rec} 15 J/cm³ or greater, preferably 20 J/cm³ or greater, more preferably 25 J/cm³ or greater, when measured using an electric field of 800 kV/mm.

6. The dielectric material according to claim 1 wherein the M_{W} of the fluoropolymer is greater than 200 kg/mol, preferably greater than 500 kg/mol, more preferably greater than 600 kg/mol.

7. The dielectric material according claim 1 wherein the fluoropolymer comprises crystallites, wherein the mean size of crystallites is less than 20 nm, preferably less than 10 nm, more preferably less than 5 nm.

8. The dielectric material according to claim 1 wherein the energy efficiency (η%) is greater than 25%, preferably greater than 35%, more preferably greater than 50% when measured using an electric field of 300 kV/mm.

9. The material according to claim 1 having relaxor-like ferroelectric properties.

10. A process for producing a fluoropolymer based dielectric material, such as a film, comprising the steps of (a) providing a layered fluoropolymer sample and (b) pressing the layers of the layered fluoropolymer sample together via the application of pressure.

11. The process of claim 10 wherein the cycle of steps (a) and (b) is repeated a total of n times, wherein n is greater than 1, preferably greater than 3, more preferably greater than 5.

12. The process of claim 10, wherein in at least one step (a) the layered fluoropolymer is obtained :(i) by stacking multiple fluoropolymer samples; by folding a fluoropolymer sample upon itself a number of times; or (iii) by rolling a fluoropolymer sample up to form a multi-layered tube.

13. The process of claim 10 wherein cycle of steps (a) and (b) is repeated a total of n times by further folding the fluoropolymer sample obtained in step (b) upon itself to provide a further layered fluoropolymer sample, wherein n is greater than 1, preferably greater than 3, more preferably greater than 5.

14. The process of claims 11, wherein the number of layers in at least one step (a) is greater than or equal to 2, preferably greater than or equal to 4, more preferably greater than or equal to 6.

15. The process of claim 11, wherein in at least one of the processing cycles, step (a) and/or step (b), preferably all of the pressing steps (b), is carried out at a temperature greater than or equal to 25° C. and less than or equal to 210° C., preferably greater than or equal to 70° C. and less than or equal to 185° C.

16. The process of claim 11 wherein in at least one, preferably all, of the processing cycles the polymer is heated to within 40° C. of the melting temperature of the polymer during step (a) and/or step (b).

17. The process of claim 11 wherein in at least one, preferably all, of the processing cycles the pressing step (b) is performed at a pressure of greater than or equal 10 Mpa, preferably greater than or equal to 20 MPa and less than or equal to 200 MPa, more preferably greater than or equal to 50 MPa and less than or equal to 180 MPa.

18. The process of claim 10, wherein the fluoropolymer is PVDF, preferably PVDF homopolymer.

19. The process of claim 11 which is performed in a continuous manner, and wherein said process comprises an extrusion step to form a sheet; a folding step and a rolling step, wherein the material is compressed between a roller and a surface and/or a further roller.

20. A dielectric material obtainable by the process of claim 10.
